(19) United States
(12) Patent Application Publication
(10) Pub. No.: US 2014/0098335 A1
(43) Pub. Date: Apr. 10, 2014

(54) LIQUID CRYSTAL DISPLAY DEVICE

(71) Applicants: Tsuyoshi Kamada, Osaka-shi (JP); Hidefumi Yoshida, Osaka-shi (JP); Tsuyoshi Maeda, Osaka-shi (JP)

(72) Inventors: Tsuyoshi Kamada, Osaka-shi (JP); Hidefumi Yoshida, Osaka-shi (JP); Tsuyoshi Maeda, Osaka-shi (JP)

(73) Assignee: SHARP KABUSHIKI KAISHA, Osaka-shi, Osaka (JP)

(21) Appl. No.: 14/122,526

(22) PCT Filed: Jun. 1, 2012
(86) PCT No.: PCT/JP2012/064277

§ 371 Date: Nov. 26, 2013

(30) Foreign Application Priority Data
Jun. 3, 2011 (JP) 2011-125186

(51) Int. Cl. G02F 1/1343

(52) U.S. Cl. CPC G02F 1/134309
USPC 349/142

(57) ABSTRACT

A liquid crystal display device includes a pair of substrates disposed to be opposed to each other, a liquid crystal layer sandwiched between the pair of substrates, a lower-layer electrode disposed between one of the substrates and the liquid crystal layer, an insulating film that covers the lower-layer electrode, and an upper-layer electrode disposed on the insulating film. The lower-layer electrode includes a plurality of lower-layer electrode fingers spaced a predetermined interval apart from each other. The upper-layer electrode includes a plurality of upper-layer electrode fingers spaced a predetermined interval apart. The plurality of lower-layer electrode fingers intersects the plurality of upper-layer electrode fingers at a predetermined angle greater than 0 degrees and smaller than 90 degrees if viewed from a direction normal to the one of the substrates.

### TECHNICAL FIELD

The present invention relates to a liquid crystal display device.

This application is based on and claims the priority of Japanese Patent Application No. 2011-125186, filed in Japan on Jun. 3, 2011, the entire contents of which are incorporated herein by reference.

### BACKGROUND ART

The in-plane electric field method has been known as a method of applying an electric field to a liquid crystal layer in a liquid crystal display device. A liquid crystal display device of the in-plane electric field method includes a pair of substrates with a liquid crystal layer sandwiched therebetween. A common electrode and pixel electrodes are disposed on one of the substrates, and an electric field in a generally in-plane direction (in a direction generally parallel to the substrate) is applied to the liquid crystal layer. Since directors of liquid crystal molecules do not stand in a vertical direction in such a case, the liquid crystal display device provides the advantage of a wide viewing angle. Depending on an electrode structure difference, the liquid crystal display devices of the in-plane electric field method are divided into a liquid IPS (In-plane Switching) liquid crystal display device and an FFS (Fringe Field Switching) liquid crystal display device.

The FFS liquid crystal display device typically includes a lower-layer electrode formed on a generally entire region within a pixel and an upper-layer electrode having multiple slits disposed on an insulating film on the lower-layer electrode (as disclosed in PTL 1 below). In another liquid crystal display device disclosed (PTL 2 below), a common electrode (lower-layer electrode) and a pixel electrode (upper-layer electrode) have a folded shape within a pixel, and a data line has also a folded shape extending in parallel with these electrodes. The pixel has multi-domains as a result of the folded shape of the common electrode and the pixel electrode, and the liquid crystal display device thus provides an increased viewing angle.

In yet another liquid crystal display device disclosed (PTL 3 below), multiple apertures are arranged in the lower-layer electrode in addition to the upper-layer electrode. The liquid crystal display device includes an aperture in a portion of the lower-layer electrode that overlaps the upper-layer electrode. For this reason, an area where the upper-layer electrode and the lower-layer electrode overlap becomes smaller. As a result, a load capacitance formed by the upper-layer electrode, the lower-layer electrode, and the insulating film sandwiched therebetween can be reduced. In this way, a write speed of information on the liquid crystal increases and a high-quality image is thus displayed.

### CITATION LIST

### Patent Literature

PTL 1: Japanese Patent No. 3498163
PTL 2: Japanese Unexamined Patent Application Publication No. 2008-9371
PTL 3: Japanese Unexamined Patent Application Publication No. 2009-116058

### SUMMARY OF INVENTION

### Technical Problem

If a load capacitance is high, a large quantity of charge needs to be written for a short period of time in order to set a pixel electrode to a predetermined voltage. This involves a size increase of a TFT element. The size increase of the TFT element leads to a decrease in production yield. Since the load capacitance of a bus line viewed from an external drive circuit that drives a liquid crystal cell also increases, the burden of driving increases. As a result, power consumption for driving increases, and the increased power consumption is not desirable in mobile applications. In the applications of television, it is difficult to introduce a large screen size design, and doubled-speed driving or quadrupled-speed driving for response improvement and stereoscopic display.

In the liquid crystal display device of PTL 3, the aperture is formed in the portion of the lower-layer electrode overlapping the upper-layer electrode, but the overlapping portion of the upper-layer electrode and the lower-layer electrode has a long extension along the longitudinal direction of the slit, and the reduction effect of the load capacitance is still subject to limitation. It is thus desirable to cut down on the load capacitance even further. Furthermore in the liquid crystal display device of PTL 3, the upper-layer electrode may be misaligned from the lower-layer electrode in a manufacturing process, and the area of the overlapping portion between the upper-layer electrode and the lower-layer electrode may vary, leading to variations in the load capacitance. In such a case, it is difficult to provide the liquid crystal display device having stable display characteristics.

It is an object of the present invention to provide a liquid crystal display device having an electrode structure that permits the load capacitance to be reduced. It is another object of the present invention to provide a liquid crystal display device which cuts down on characteristic variations as much as possible even if the upper-layer electrode is misaligned from the lower-layer electrode.

### Solution to Problem

A liquid crystal display device in one aspect of the present invention includes a pair of substrates disposed to be opposed to each other, a liquid crystal layer sandwiched between the pair of substrates, a lower-layer electrode disposed between one of the substrates and the liquid crystal layer, an insulating film that covers the lower-layer electrode, and an upper-layer electrode disposed on the insulating film. The lower-layer electrode includes a plurality of lower-layer electrode fingers spaced a predetermined interval apart from each other. The upper-layer electrode includes a plurality of upper-layer electrode fingers spaced a predetermined interval apart. The plurality of lower-layer electrode fingers intersects the plurality of upper-layer electrode fingers at a predetermined angle greater than 0 degrees and smaller than 90 degrees if viewed from a direction normal to the one of the substrates.

In the liquid crystal display device in another aspect of the present invention, the one of the substrates includes a plurality of pixel regions disposed in a matrix. The plurality of lower-layer electrode fingers extends in parallel with a layout direction of the plurality of pixel regions, and the plurality of upper-layer electrode fingers extends at a slant angle with respect to the layout direction of the plurality of pixels.

In the liquid crystal display device in another aspect of the present invention, a line width of a first region of each of the lower-layer electrode fingers in at least one close area to an intersection region of each of the lower-layer electrode fingers and each of the upper-layer electrode fingers is larger than a line width of a second region adjacent to the first region and other than the at least one close area.

In the liquid crystal display device in another aspect of the present invention, an outline of a portion of the first region of each of the lower-layer electrode fingers adjacent to the second region makes an angle greater than 0 degrees and smaller than 90 degrees with respect to an longitudinal direction of the lower-layer electrode fingers.

In the liquid crystal display device in another aspect of the present invention, the outline of the portion of the first region of each of the lower-layer electrode fingers adjacent to the second region is generally parallel with an outline of each of the upper-layer electrode fingers.

In the liquid crystal display device in another aspect of the present invention, each of the lower-layer electrode fingers has a cutout in at least one of the intersection regions of the lower-layer electrode fingers and the upper-layer electrode fingers.

In the liquid crystal display device in another aspect of the present invention, an expression L1+S1>L2+S2 holds where L1 represents a line width of each of the upper-layer electrode fingers, S1 represents a line spacing between adjacent upper-layer electrode fingers, L2 represents a line width of each of the lower-layer electrode fingers, and S2 represents a line spacing between adjacent lower-layer electrode fingers.

In the liquid crystal display device in another aspect of the present invention, expressions L1+S1=L2+S2 and L1<L2 hold where L1 represents a line width of each of the upper-layer electrode fingers, S1 represents a line spacing between adjacent upper-layer electrode fingers, L2 represents a line width of each of the lower-layer electrode fingers, and S2 represents a line spacing between adjacent lower-layer electrode fingers.

### Advantageous Effects of Invention

According to the present invention, the liquid crystal display device cuts down on the load capacitance, and provides improved display characteristics. Even if the upper-layer electrode is misaligned from the lower-layer electrode, the liquid crystal display device sufficiently controls characteristic variations.

### BRIEF DESCRIPTION OF DRAWINGS

FIG. 1 is an exploded perspective view diagrammatically illustrating a liquid crystal display device of a first embodiment.

FIG. 2 is a plan view illustrating a single pixel of the liquid crystal display device of the present embodiment.

FIG. 3A illustrates an electrode within a pixel, namely, is a plan view of a lower-layer electrode.

FIG. 3B illustrates an electrode within the pixel, namely, is a plan view of an upper-layer electrode.

FIG. 4A illustrates an operation of the liquid crystal display device of the present embodiment.

FIG. 4B illustrates the operation of the liquid crystal display device of the present embodiment.

FIG. 5 illustrates a modification of a TFT of the liquid crystal display device of the present embodiment.

FIG. 6 is a plan view illustrating a single pixel in a liquid crystal display device of a second embodiment.

FIG. 7A illustrates an electrode within a pixel, namely, is a plan view of a lower-layer electrode.

FIG. 7B illustrates an electrode within the pixel, namely, is a plan view of an upper-layer electrode.

FIG. 8 is an expanded plan view of intersection regions of the lower-layer electrode fingers and the upper-layer electrode fingers.

FIG. 9 is a plan view illustrating a single pixel of a liquid crystal display device of a third embodiment.

FIG. 10A illustrates an electrode within a pixel, namely, is a plan view of a lower-layer electrode.

FIG. 10B illustrates an electrode within the pixel, namely, is a plan view of an upper-layer electrode.

FIG. 11 is an expanded plan view of intersection regions of the lower-layer electrode fingers and the upper-layer electrode fingers.

FIG. 12 is a plan view illustrating a single pixel of a liquid crystal display device of a fourth embodiment.

FIG. 13A illustrates an electrode within a pixel, namely, is a plan view of a lower-layer electrode.

FIG. 13B illustrates an electrode within the pixel, namely, is a plan view of an upper-layer electrode.

FIG. 14 is an expanded plan view of intersection regions of the lower-layer electrode fingers and the upper-layer electrode fingers.

FIG. 15 is a plan view illustrating a single pixel of the liquid crystal display device of a fifth embodiment.

FIG. 16A illustrates an electrode within a pixel, namely, is a plan view of a lower-layer electrode.

FIG. 16B illustrates an electrode within the pixel, namely, is a plan view of an upper-layer electrode.

FIG. 17 is a plan view illustrating a single pixel of a liquid crystal display device of a sixth embodiment.

FIG. 18A illustrates an electrode within a pixel, namely, is a plan view of a lower-layer electrode.

FIG. 18B illustrates an electrode within the pixel, namely, is a plan view of an upper-layer electrode.

FIG. 19 is a plan view illustrating a single pixel of a liquid crystal display device of a seventh embodiment.

FIG. 20A illustrates an electrode within a pixel, namely, is a plan view of a lower-layer electrode.

FIG. 20B illustrates an electrode within the pixel, namely, is a plan view of an upper-layer electrode.

FIG. 21A illustrates an electrode pattern used in a simulation test of a first example, namely, is a plan view of the lower-layer electrode.

FIG. 21B illustrates an electrode pattern used in the simulation test of the first example, namely, is a plan view of the upper-layer electrode.

FIG. 22 illustrates a transmittance distribution within a pixel of the present example.

FIG. 23A illustrates an equipotential line and a distribution of directors of liquid crystal molecules at positions along A-A′ line of FIG. 22.

FIG. 23B illustrates an equipotential line and a distribution of directors of liquid crystal molecules at positions along B-B′ line of FIG. 22.

FIG. 24A illustrates an electrode pattern used in a simulation test of a second example, namely, is a plan view of the lower-layer electrode.

FIG. 24B illustrates an electrode pattern used in the simulation test of the second example, namely, is a plan view of the upper-layer electrode.

FIG. 25 illustrates a transmittance distribution within a pixel of the present example.

FIG. 26 illustrates an equipotential line and a distribution of directors of liquid crystal molecules at positions along A-A′ line of FIG. 25.

FIG. 27A illustrates an electrode pattern used in a simulation test of a third example, namely, is a plan view of the lower-layer electrode.

FIG. 27B illustrates an electrode pattern used in the simulation test of the third example, namely, is a plan view of the upper-layer electrode.

FIG. 28 illustrates a transmittance distribution within a pixel of the present example.

FIG. 29 is a plot of a relationship between an applied voltage and capacitance in the first through third examples.

FIG. 30 is a plot of a relationship between an applied voltage and transmittance in the first through third examples.

FIG. 31A illustrates an electrode pattern used in a simulation test of a fourth example, namely, is a plan view of the lower-layer electrode.

FIG. 31B illustrates an electrode pattern used in the simulation test of the fourth example, namely, is a plan view of the upper-layer electrode.

FIG. 32 illustrates a transmittance distribution within a pixel of the present example.

FIG. 33 illustrates an equipotential line and a distribution of directors of liquid crystal molecules at positions along A-A′ line of FIG. 32.

FIG. 34 is a plot of a relationship between an applied voltage and capacitance in the first and fourth examples.

FIG. 35 is a plot of a relationship between an applied voltage and transmittance in the first and fourth examples.

FIG. 36A illustrates an electrode pattern used in a simulation test of a fifth example, namely, is a plan view of the lower-layer electrode.

FIG. 36B illustrates an electrode pattern used in the simulation test of the fifth example, namely, is a plan view of the upper-layer electrode.

FIG. 36C illustrates an electrode pattern used in the simulation test of the fifth example, namely, is a plan view of the lower-layer electrode and the upper-layer electrode in an overlapped state thereof.

FIG. 37 illustrates a transmittance distribution within a pixel of the present example.

FIG. 38 illustrates an equipotential line and a distribution of directors of liquid crystal molecules at positions along A-A′ line of FIG. 37.

FIG. 39 is a plot of a relationship between an applied voltage and capacitance in the fifth example.

FIG. 40 is a plot of a relationship between an applied voltage and transmittance in the fifth example.

FIG. 41A illustrates an electrode pattern used in a simulation test of a comparative example (with the upper-layer electrode thereof having a fine line design), namely, is a plan view of the lower-layer electrode.

FIG. 41B illustrates an electrode pattern used in the simulation test of the comparative example (with the upper-layer electrode thereof having a fine line design), namely, is a plan view of the upper-layer electrode.

FIG. 41C illustrates an electrode pattern used in the simulation test of the comparative example (with the upper-layer electrode thereof having a fine line design), namely, is a plan view of the lower-layer electrode and the upper-layer electrode in an overlapped state thereof.

FIG. 42 illustrates a transmittance distribution within a pixel of the present example.

FIG. 43 illustrates an equipotential line and a distribution of directors of liquid crystal molecules at positions along A-A′ line of FIG. 42.

FIG. 44 is a plot of a relationship between an applied voltage and transmittance in the comparative example.

FIG. 45A illustrates an electrode pattern used in a simulation test of a sixth example, namely, is a plan view of the lower-layer electrode.

FIG. 45B illustrates an electrode pattern used in the simulation test of the sixth example, namely, is a plan view of the upper-layer electrode.

FIG. 45C illustrates an electrode pattern used in the simulation test of the sixth example, namely, is a plan view of the lower-layer electrode and the upper-layer electrode in an overlapped state thereof.

FIG. 46 illustrates a transmittance distribution within a pixel of the present example.

FIG. 47 illustrates an equipotential line and a distribution of directors of liquid crystal molecules at positions along A-A′ line of FIG. 46.

FIG. 48 is a plot of a relationship between an applied voltage and capacitance in the present example.

FIG. 49 is a plot of a relationship between an applied voltage and transmittance in the present example.

FIG. 50A illustrates an electrode pattern used in a simulation test of a seventh example, namely, is a plan view of the lower-layer electrode.

FIG. 50B illustrates an electrode pattern used in the simulation test of the seventh example, namely, is a plan view of the upper-layer electrode.

FIG. 50C illustrates an electrode pattern used in the simulation test of the seventh example, namely, is a plan view of the lower-layer electrode and the upper-layer electrode in an overlapped state thereof.

FIG. 51 illustrates a transmittance distribution within a pixel of the present example.

FIG. 52 is a plot of a relationship between an applied voltage and capacitance in the present example.

FIG. 53 is a plot of a relationship between an applied voltage and transmittance in the present example.

FIG. 54 is a front view illustrating the external appearance of the liquid crystal display device.

### DESCRIPTION OF EMBODIMENTS

### First Embodiment

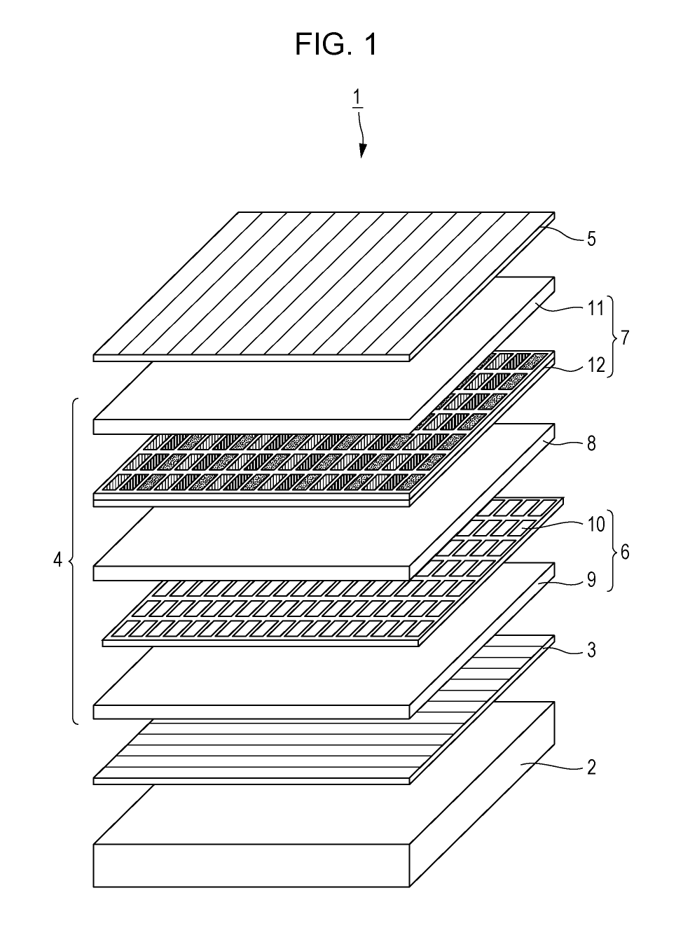

A first embodiment of the present invention is described with reference to FIG. 1 through FIG. 5.

The liquid crystal display device of the present embodiment includes a pair of substrates, a liquid crystal layer sandwiched between the substrates, and a pair of electrodes on one of the substrates. The liquid crystal display device is of an in-plane electric field driving type that drives liquid crystal by an electric field applied between the pair of electrodes.

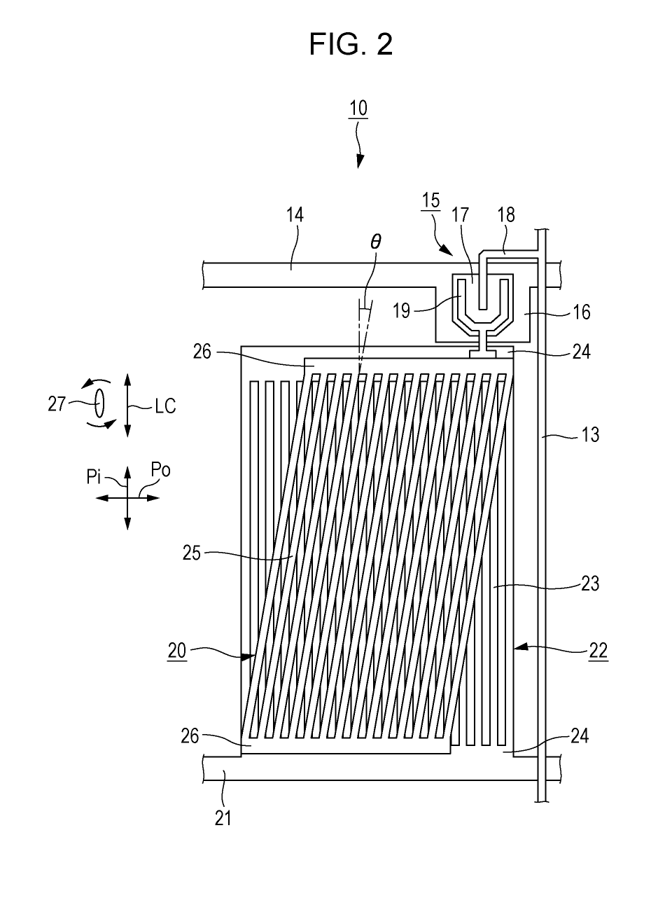

FIG. 1 is an exploded perspective view diagrammatically illustrating the liquid crystal display device of the present embodiment. FIG. 2 is a plan view illustrating a single pixel of the liquid crystal display device of the present embodiment.

Scales of elements in each of the drawings may be set to be different to cause the elements to be easily viewable.

Referring to FIG. 1, the liquid crystal display device 1 of the present embodiment includes a backlight 2, a polarizer 3, a liquid crystal cell 4, and a polarizer 5. The liquid crystal display device 1 of the present embodiment is thus a transmissive liquid crystal display device and causes the liquid crystal cell 4 to control transmittance of light emitted from the backlight 2 to display images.

The liquid crystal cell 4 includes a thin film transistor (hereinafter referred to as TFT) array substrate 6, a counter substrate 7 opposed to the TFT array substrate 6, and a liquid crystal layer 8 sandwiched between the TFT array substrate 6 and the counter substrate 7. The liquid crystal layer 8 is typically manufactured of a positive type liquid crystal, but instead, a negative type liquid crystal may be used for the liquid crystal layer 8. The TFT array substrate 6 includes a substrate 9 and a plurality of pixel regions 10 disposed in a matrix on the substrate 9, and the pixel regions 10 form a display area (screen). The counter substrate 7 includes a substrate 11 and a color filter 12 disposed on the substrate 11.

The display area includes a plurality of source bus lines arranged mutually in parallel with each other and a plurality of gate bus lines arranged mutually in parallel with each other, though these lines are not illustrated in FIG. 1. The plurality of source bus lines intersects the plurality of gate bus lines. More specifically, the display area is delineated into a grid pattern by the plurality of source bus lines and the plurality of gate bus lines. Each delineated rectangular region becomes the pixel region 10.

The pixel region 10 includes a TFT 15 near an intersection region of the source bus line 13 and the gate bus line 14 as illustrated in FIG. 2. The TFT 15 of the present embodiment includes a gate electrode 16 integrally formed with the gate bus line 14, a semiconductor layer 17 disposed on the gate electrode 16, a source electrode 18 integrally formed with the source bus line 13, and a drain electrode 19.

The drain electrode 19 has a letter-U shape, and is formed to surround the source electrode 18. The drain electrode 19 is electrically connected to an upper-layer electrode 20 to be described below. In the pixel region 10, a common bus line 21 is arranged along the side of the pixel region 10 opposite the side along which the gate bus line 14 runs. The common bus line 21 is electrically connected to a lower-layer electrode 22 to be described below.

FIG. 2 illustrates the lower-layer electrode 22 and the upper-layer electrode 20 in an overlapped state. However, an insulating film is formed to cover the lower-layer electrode 22 and the upper-layer electrode 20 is disposed on the insulating film. Since the lower-layer electrode 22 is connected to the common bus line 21 in the present embodiment, a common potential (such as 0 V) is applied to the lower-layer electrode 22. Since the upper-layer electrode 20 is connected to the drain electrode 19 of the TFT 15, a pixel potential (such as+several V) is applied to the upper-layer electrode 20.

The potentials to be applied is not limited to the application direction described above. The pixel potential may be applied to the lower-layer electrode 22 and the common potential may be applied to the upper-layer electrode 20. Regardless of which potential is applied to which electrode, equivalent results are considered achievable. Therefore, conversely, the lower-layer electrode 22 may be connected to the drain electrode 19 of the TFT 15, and the upper-layer electrode 20 may be connected to the common bus line 21.

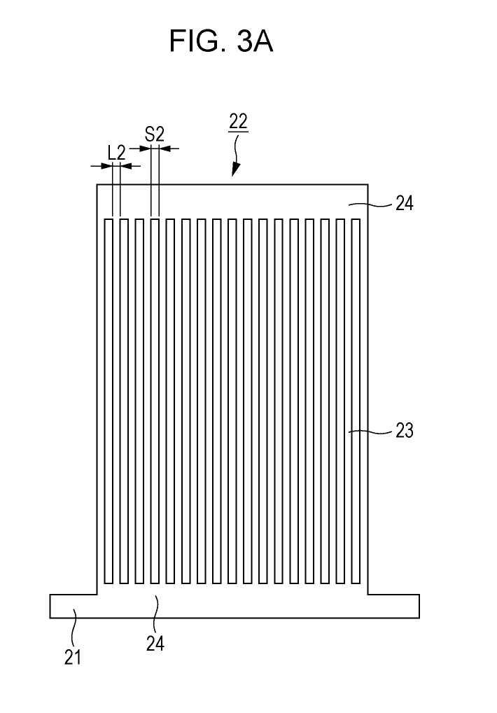

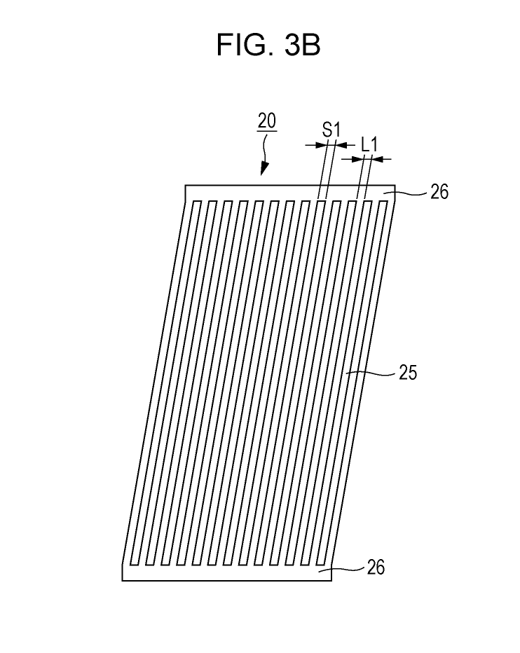

As illustrated in FIG. 3A, the lower-layer electrode 22 includes a plurality of lower-layer electrode fingers 23 arranged mutually in parallel with each other a predetermined spacing apart. The plurality of lower-layer electrode fingers 23 are connected together by connection portions 24 illustrated on an upper side and a lower side of FIG. 3A, and are thus electrically connected together. Also, the lower-layer electrode fingers 23 extend in parallel with the source bus line 13. In other words, the plurality of lower-layer electrode fingers 23 is arranged to extend in parallel with the layout direction of the plurality of pixel regions 10.

As illustrated in FIG. 3B, the upper-layer electrode 20 includes a plurality of upper-layer electrode fingers 25 arranged mutually in parallel with each other a predetermined spacing apart. The plurality of upper-layer electrode fingers 25 are connected together by connection portions 26 illustrated on an upper side and a lower side of FIG. 3B, and are thus electrically connected together. Also, the upper-layer electrode fingers 25 are arranged to intersect the lower-layer electrode fingers 23 at a predetermined angle greater than 0 degrees and smaller than 90 degrees. In the present embodiment, the upper-layer electrode finger 25 intersects the lower-layer electrode finger 23 at an angle of 10 degrees. More specifically, as illustrated in FIG. 2, a crossing angle θ between the upper-layer electrode finger 25 and the lower-layer electrode finger 23 is 10 degrees. Therefore, the upper-layer electrode finger 25 extends at an angle of 10 degrees with respect to the source bus line 13.

The lower-layer electrode 22 and the upper-layer electrode 20 are manufactured of a transparent conductive film, such as indium tin oxide (ITO), indium zinc oxide (IZO, registered trademark of Idemitsu Kosan Co., Ltd), or the like. The insulating film interposed between the lower-layer electrode 22 and the upper-layer electrode 20 is manufactured of silicon nitride film, for example. As dimension examples of each element, let L1 represent a line width of the upper-layer electrode finger 25, S1 represent a line spacing between adjacent upper-layer electrode fingers 25, L2 represent a line width of the lower-layer electrode finger 23, and S2 represent a line spacing between adjacent lower-layer electrode fingers 23, and L1=3 μm, S1=3 μm, L2=3 μm, and S2=3 μm. In the following discussion, the line width and line spacing of each finger may also be specified as follows: L1/S1=3/3 μm, and L2/S2=3/3 μm. A film thickness of the transparent conductive film forming the lower-layer electrode 22 is 80 nm, a film thickness of the transparent conductive film forming the upper-layer electrode 20 is 80 nm, and a film thickness of the insulating film is 500 nm.

An alignment layer that has undergone an alignment treatment, such as rubbing, is disposed on the surface of each of the TFT array substrate 6 and the counter substrate 7, facing the liquid crystal layer 8. The alignment layer anchors, in alignment direction, liquid crystal molecules 27 forming the liquid crystal layer 8 with no electric field applied. In the following discussion, the alignment direction of the liquid crystal molecules 27 with no electric field applied is referred to as an initial alignment direction. In the present embodiment, the alignment process in the same direction is performed on the alignment layer of the TFT array substrate 6 and the alignment layer of the counter substrate 7. As denoted by an arrow labeled LC in FIG. 2, the alignment process direction, in other words, the initial alignment direction of the liquid crystal molecules 27 is anchored to a direction in parallel with the longitudinal direction of the lower-layer electrode finger 23.

In other words, the initial alignment direction of the liquid crystal molecules 27 is anchored to a direction that makes an angle of 10 degrees with the longitudinal direction of the upper-layer electrode finger 25. If the positive type liquid crystal display device is used with a voltage applied between the lower-layer electrode 22 and the upper-layer electrode 20, the liquid crystal molecules 27 rotate counterclockwise in a plane substantially parallel with the substrates in accordance with an in-plane electric field generated between the electrodes 22 and 20.

The two polarizers 3 and 5 are respectively arranged on the outsider sides of the liquid crystal cell 4 and are disposed in a cross-Nichol arrangement so that transmission axes of the polarizers are respectively in parallel with and vertical to the initial alignment direction of the liquid crystal molecules 27. For example, as illustrated in FIG. 2, the polarizer 3 on the light incident side of the liquid crystal cell 4 is arranged so that the transmission axis thereof faces in parallel with the longitudinal direction of the lower-layer electrode finger 23 (a direction labeled an arrow Pi). The polarizer 5 on the light exit side of the liquid crystal cell 4 is arranged so that the transmission axis thereof faces in perpendicular to the longitudinal direction of the lower-layer electrode finger 23 (a direction labeled an arrow Po). The arrangement of the two transmission axes between the polarizer 3 on the light incident side and the polarizer 5 on the light exit side of the liquid crystal cell 4 may be opposite to that described above. With the polarizers 3 and 5 arranged in this way, the liquid crystal display device 1 of the present embodiment functions as a normally black mode liquid crystal display device in which a black display is presented with no electric field applied and a white display is presented with an electric field applied.

In a known ordinary FFS liquid crystal display device, the lower-layer electrode is disposed over the generally entire surface of the pixel region, and overlaps the generally entire area where the lower-layer electrode is present. If the ratio of the line width to the line spacing of the upper-layer electrode is 1:1 in such a case, the two electrodes overlap each other in half the entire electrode formation region thereof, and a large load capacitance results.

In contrast, in the liquid crystal display device 1 of the present embodiment, not only the upper-layer electrode 20 includes the plurality of electrode fingers but also the lower-layer electrode 22 includes the plurality of lower-layer electrode fingers 23, and each of the upper-layer electrode fingers 25 intersects each of the lower-layer electrode fingers 23 at an angle of 10 degrees. This arrangement causes only the intersection region of the upper-layer electrode finger 25 and the lower-layer electrode finger 23 to be only an area where the upper-layer electrode 20 overlaps the lower-layer electrode 22. For this reason, the liquid crystal display device 1 of the present embodiment greatly cuts down on the load capacitance in comparison with the known FFS liquid crystal display device. As a result, power consumption for driving is reduced, and the liquid crystal display device of the present embodiment is appropriate in mobile applications. In television applications, a large screen size, and doubled-speed driving or quadrupled-speed driving for response improvement and stereoscopic display may be introduced without difficulty.

In the liquid crystal display device disclosed in PTL 3, an overlapping portion between the upper-layer electrode and the lower-layer electrode runs over a large extension along the longitudinal direction of a slit. If the upper-layer electrode is misaligned from the lower-layer electrode, the area of the overlapping portion of the upper-layer electrode and the lower-layer electrode varies, leading to variations in the load capacitance. In contrast, almost no variations occur in the load capacitance in the liquid crystal display device 1 of the present embodiment. This is because the area of the overlapping portion of the upper-layer electrode 20 and the lower-layer electrode 22 remains mostly unchanged even if the upper-layer electrode 20 is misaligned from the lower-layer electrode 22.

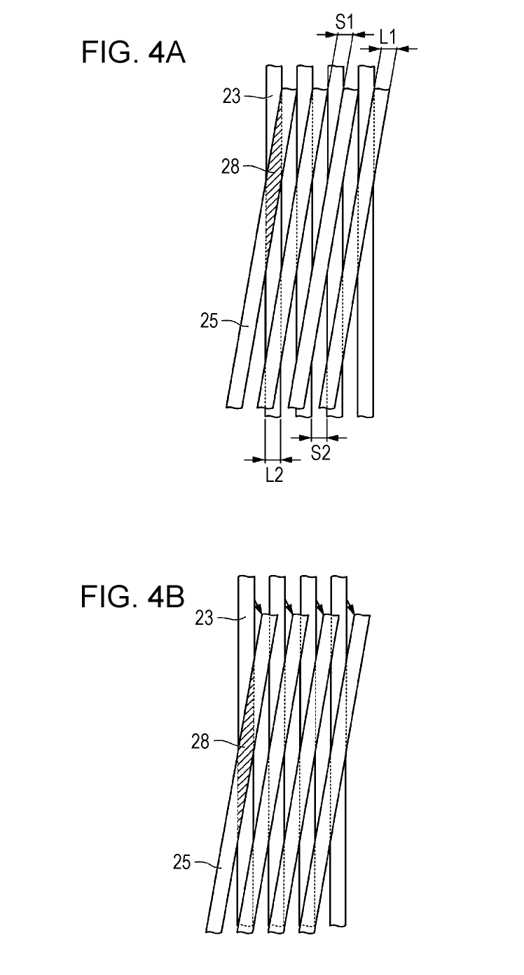

FIG. 4A and FIG. 4B are expanded views of a portion of each of the lower-layer electrode fingers 23 and the upper-layer electrode fingers 25. With the dimensions of the lower-layer electrode fingers 23 and 25 being L1/S1=3/3 μm, and L2/S2=3/3 μm, the upper-layer electrode fingers 25 are shifted in a right direction by 1.5 μm and in a down direction by 3.0 μm. FIG. 4A illustrates the fingers in a normal state thereof, and FIG. 4B illustrates the fingers in a shifted state thereof. In the present embodiment, a region of a parallelogram denoted by reference numeral 28 is an intersection region of the lower-layer electrode finger 23 and the upper-layer electrode finger 25. The overall area of all the intersection regions 28 occupies a quarter of the overall area of the electrode formation region. In terms of the area calculation, the present embodiment cuts down on the load capacitance by 50% with respect to the known FFS liquid crystal display device.

In the present embodiment, the lower-layer electrode finger 23 obliquely intersects the upper-layer electrode finger 25. As illustrated in FIG. 4A and FIG. 4B, an intersection region 28 between the lower-layer electrode finger 23 and the upper-layer electrode finger 25 only shifts when the upper-layer electrode 20 is misaligned from the upper-layer electrode 22. The area of the intersection region 28 remains unchanged. The spacing between the lower-layer electrode finger 23 and the upper-layer electrode finger 25 varies in a localized fashion, but remains unchanged in a general view. The present embodiment in this way is free from variations in the load capacitance and variations in voltage-luminance characteristics, caused by the misalignment between the upper-layer electrode 20 and the lower-layer electrode 22.

Since the electrode formation region is typically rectangular, the effect caused by the misalignment occurs at the four sides, namely, the top and bottom sides, and right and left sides of the electrode formation region (in the periphery of a pixel) in practice. However, the effect of the periphery of the pixel on the entire pixel is marginal in view of the area ratio, and is thus almost negligible. If the upper-layer electrode 20 is misaligned from the lower-layer electrode 22 within an in-plane rotation direction, it seems that the area of the intersection regions 28 varies. In the manufacturing process of the liquid crystal display device, a large misalignment in the rotation direction is less likely. Even if a slight misalignment occurs in the rotation direction, the effect thereof is minimal, and almost negligible.

In the present embodiment, the plurality of lower-layer electrode fingers 23 extends in parallel with the longitudinal direction of the source bus line 13 (in the layout direction of the pixels), and the plurality of upper-layer electrode fingers 25 extends at an angle of 10 degrees with respect to the plurality of lower-layer electrode fingers 23. For this reason, it is sufficient enough if the alignment process direction of the TFT array substrate 6 and the counter substrate 7 is set to be the longitudinal direction of the source bus line 13 (the layout direction of the pixels), in other words, is set to be in parallel with or vertical to the outlines of the TFT array substrate 6 and the counter substrate 7. This arrangement of the electrodes is preferred in that the alignment process, such as rubbing, is easy to perform. It is also sufficient enough if the transmission axes of the polarizers 3 and 5 are set to be in parallel with or vertical to the outline of the TFT array substrate 6 and the counter substrate 7. This arrangement of the electrodes is preferred in that the polarizers 3 and 5 are easily arranged.

If these advantages are not important, an arrangement opposite to the above arrangement may be implemented so that the plurality of lower-layer electrode fingers 23 may be arranged at an angle of 10 degrees with respect to the longitudinal direction of the source bus line 13 (the layout direction of the pixels), and the plurality of upper-layer electrode fingers 25 may be arranged in parallel with the longitudinal direction of the source bus line 13 (the layout direction of the pixels).

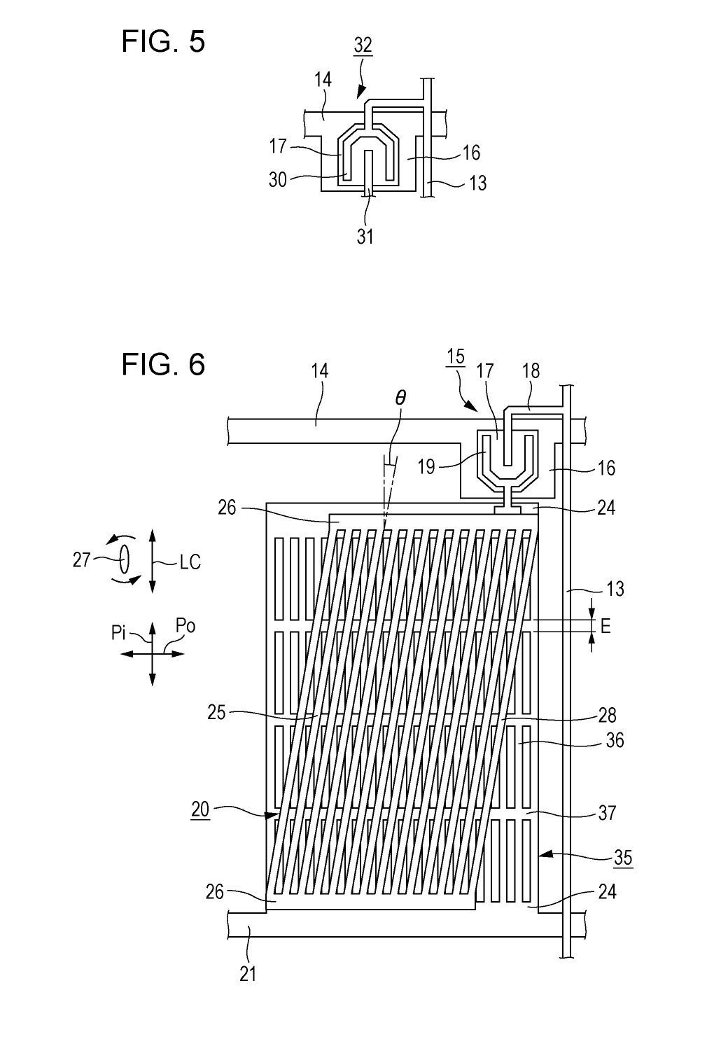

In the present embodiment, the TFT 15 is constructed so that the U-shaped drain electrode 19 surrounds the source electrode 18. A TFT 32 arranged as illustrated in FIG. 5 contrary to this arrangement may be used. In the TFT 32, a source electrode 30 connected to the source bus line 13 is U-shaped, and the U-shaped electrode 30 may surround a linear drain electrode 31. However, in view of better compatibility with the FFS liquid crystal display device serving as a base of the liquid crystal display device of the present embodiment, the use of the U-shaped drain electrode of the present embodiment is more desirable than the use of the U-shaped source electrode.

The reason for this is described below.

One of the drain electrode and the source electrode is U-shaped so that the U-shaped electrode surrounds the other electrode. This increases W/L (gate width/gate length) of the TFT, thereby increasing charge write performance to the pixel. On the other hand, if one of the drain electrode and the source electrode is U-shaped, the area where the electrodes overlap the gate electrode increases. As a result, the use of the U-shaped drain electrode increases a parasitic capacitance Cgd between the gate and the drain while the use of the U-shaped source electrode increases a parasitic capacitance Cgs between the gate and the source. Generally speaking, an increase in the gate-drain parasitic capacitance Cgd leads to an increase in a field-through voltage, adversely affecting the reliability of the liquid crystal display device, such as causing burning. On the other hand, an increase in the gate-source parasitic capacitance Cgs can lead to an increase in the load of the bus line, delaying signals, and causing display unevenness responsive to a difference in the distance from a driver.

The FFS liquid crystal display device tends to have a larger sum (Clc+Cs) of a liquid crystal capacitance Clc and an auxiliary capacitance Cs than other types of liquid crystal display devices. For this reason, if the gate-drain parasitic capacitance Cgd is increased to some degree by U-shaping the drain electrode, the effect of the gate-drain parasitic capacitance Cgd on the total capacitance (Clc+Cs+Cgd) is small. The gate-drain parasitic capacitance Cgd does not affect so much the reliability of the liquid crystal display device. On the other hand, if the drain electrode is U-shaped with the source electrode linearly shaped, the gate-source parasitic capacitance Cgs is reduced. The load of the source bus line decreases, thereby reducing the signal delay. As a result, a sufficient amount of charge can be written on each pixel within a short period of time, thereby decreasing the display uneveness.

### Second Embodiment

A second embodiment of the present invention is described with reference to FIG. 6 through FIG. 8.

The basic configuration of the liquid crystal display device of the present embodiment is identical to that of the first embodiment except for the structure of the lower-layer electrode.

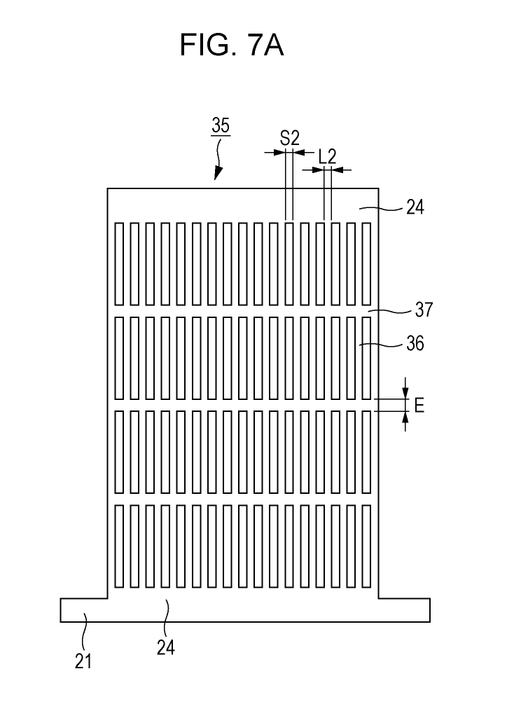

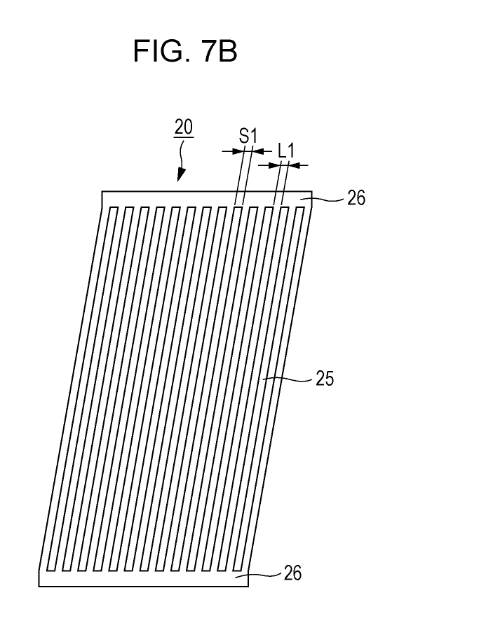

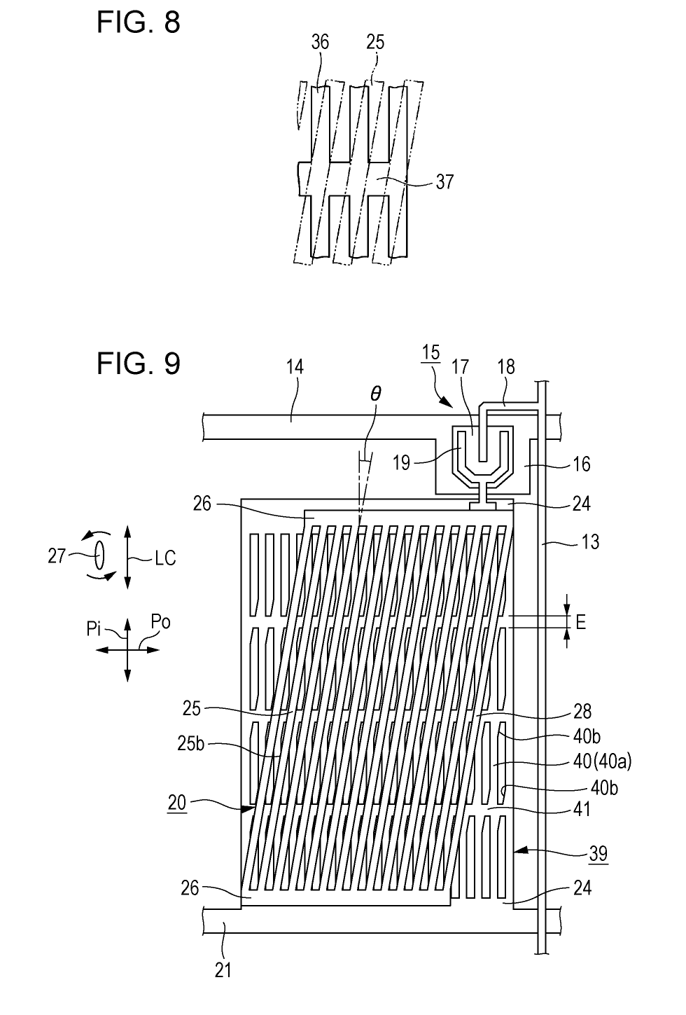

FIG. 6 is a plan view illustrating a single pixel in a liquid crystal display device of the second embodiment. FIG. 7A is a plan view of a lower-layer electrode. FIG. 7B is a plan view of an upper-layer electrode. FIG. 8 is an expanded view of intersection regions of the lower-layer electrode fingers and the upper-layer electrode fingers.

In FIG. 6 through FIG. 8, elements identical to those of the first embodiment in FIG. 1 through FIG. 3B are designated with the same reference numerals, and the discussion thereof is omitted herein.

As illustrated in FIG. 6, each lower-layer electrode finger 36 of a lower-layer electrode 35 of the present embodiment has a wider line width at an area close to an intersection region 28 of the lower-layer electrode finger 36 and an upper-layer electrode finger 25 than the remaining area other than the close area to the intersection region 28. In other words, a first portion of each lower-layer electrode finger 36 at at least one of the close areas of the intersection regions 28 of the plurality of lower-layer electrode fingers 36 and the plurality of upper-layer electrode fingers 25 has a wider line width than a second portion that is adjacent to the first portion and other than at least one close area of the intersection regions 28. In the following discussion, a portion of the lower-layer electrode finger 36 having a wider line width than a fixed line width thereof is referred to as an expanded portion 37.

As a dimension example in the present embodiment, L2/S2 of the fixed line width portion of the lower-layer electrode finger 36 may be 3/3 μm. A single lower-layer electrode finger 36 is expanded on both outlines thereof in line width by +1.5 μm. As illustrated in FIG. 7A, two adjacent lower-layer electrode fingers 36 are connected by the expanded portion 37. In this way, the occurrence of faults, such as an open circuit of the electrode pattern, is reduced. The two adjacent lower-layer electrode fingers 36 do not necessarily have to be connected by the expanded portion 37, and adjacent expanded portions 37 may be separated from each other. One example of dimension E of the expanded portion 37 in the longitudinal direction of the lower-layer electrode finger 36 is 5 μm. The dimension E of the expanded portion 37 may be modified as appropriate.

The rest of the structure is identical to that of the first embodiment.

Since the present embodiment cuts down on the load capacitance in comparison with the known FFS liquid crystal display device, the same advantages as those of the first embodiment are provided including reducing power consumption for driving and performing high-speed driving without difficulty.

In the first embodiment, the lower-layer electrode finger 23 is not exposed out of the outline of the upper-layer electrode finger 25 in the intersection region 28 of the lower-layer electrode finger 23 and the upper-layer electrode finger 25 if viewed from a direction normal to the TFT array substrate 6. Therefore, no in-plane electric field is generated near the intersection region 28 of the lower-layer electrode finger 23 and the upper-layer electrode finger 25 with a voltage applied, and the liquid crystal molecules are not aligned in a desired direction, possibly causing transmittance to drop. From this point of view, the expanded portion 37 is provided near the intersection region 28 of the lower-layer electrode finger 36 and the upper-layer electrode finger 25 in the present embodiment as illustrated in FIG. 8, and is thus exposed laterally out of the outlines of the upper-layer electrode finger 25. As a result, an in-plane electric field is generated near the intersection region 28 of the lower-layer electrode finger 36 and the upper-layer electrode finger 25 with the voltage applied, and the liquid crystal molecules are aligned in the desired direction. A drop in transmittance is thus controlled.

Since the expanded portion 37 of the lower-layer electrode finger 36 is located at an area where the upper-layer electrode finger 25 is not present, there is almost no increase in the area where the lower-layer electrode finger 36 and the upper-layer electrode finger 25 overlap each other.

Therefore, an increase in the load capacitance is minimized.

### Third Embodiment

A third embodiment of the present invention is described with reference to FIG. 9 through FIG. 11.

The basic configuration of the liquid crystal display device of the present embodiment is identical to that of the first embodiment except for the structure of the lower-layer electrode.

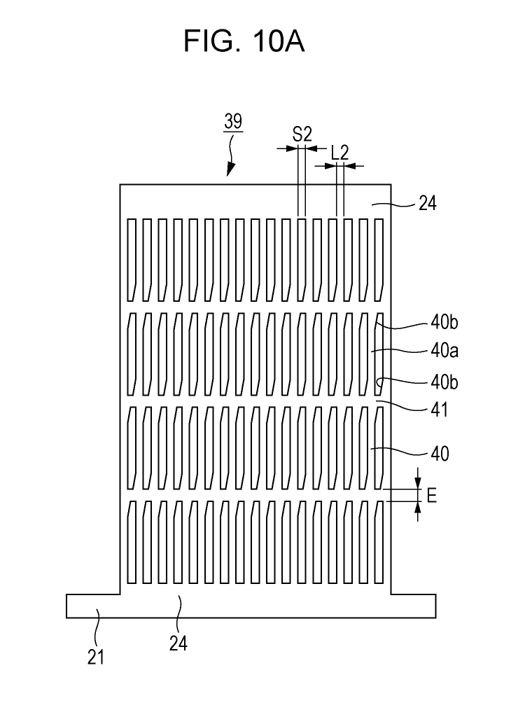

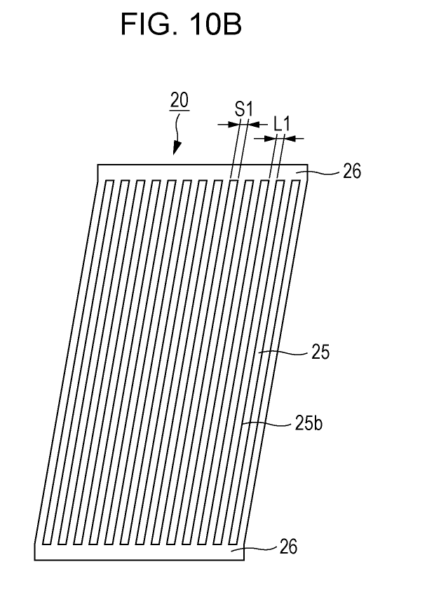

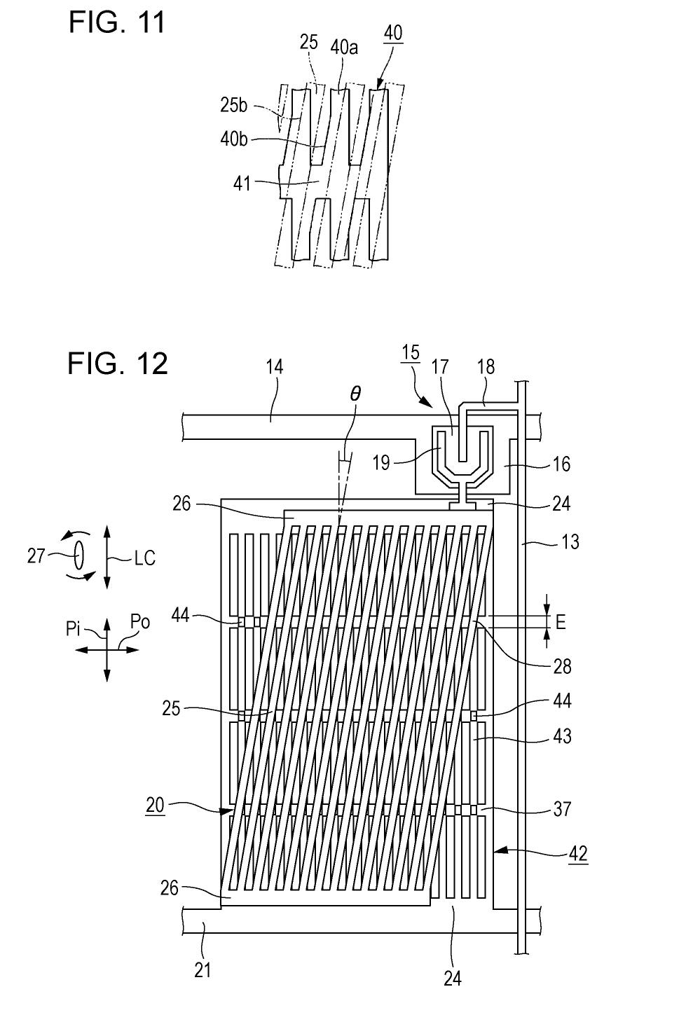

FIG. 9 is a plan view illustrating a single pixel in a liquid crystal display device of the present embodiment. FIG. 10A is a plan view of a lower-layer electrode. FIG. 10B is a plan view of an upper-layer electrode. FIG. 11 is an expanded view of intersection regions of the lower-layer electrode and the upper-layer electrode.

In FIG. 9 through FIG. 11, elements identical to those of the first embodiment in FIG. 1 through FIG. 3B are designated with the same reference numerals, and the discussion thereof is omitted herein.

In a lower-layer electrode 39 of the present embodiment as illustrated in FIG. 9 and FIG. 10A, an outline 40b of a lower-layer electrode finger 40 extending from a fixed line width portion 40a of the lower-layer electrode finger 40 to an expanded line width portion 41 obliquely extends at an angle other than 90 degrees with respect to the outline of the lower-layer electrode finger 40 along the fixed line width portion 40a in an close area of the intersection region 28 between the lower-layer electrode finger 40 and the upper-layer electrode finger 25. More specifically, the outline 40b of the lower-layer electrode finger 40 extending from the fixed line width portion 40a of the lower-layer electrode finger 40 to the expanded line width portion 41 obliquely extends at an angle 10 degrees with respect to the outline of the lower-layer electrode finger 40 along the fixed line width portion 40a. In other words, in the lower-layer electrode finger 39, an outline of the expanded line width portion 41 close to the fixed line width portion 40a makes an angle greater than 0 degrees and smaller than 90 degrees with respect to the longitudinal direction of the lower-layer electrode finger 39.

Since the outline 40b of the lower-layer electrode finger 40 extending from the fixed line width portion 40a of the lower-layer electrode finger 40 to the expanded line width portion 41 is designed described above, the outline 40b of the lower-layer electrode finger 40 extending from the fixed line width portion 40a of the lower-layer electrode finger 40 to the expanded line width portion 41 is substantially parallel with an outline 25b of the upper-layer electrode finger 25 as illustrated in FIG. 11.

In other words, the lower-layer electrode 39 of FIG. 10A is shaped by replacing the corners of an elongated slit between adjacent lower-layer electrode fingers 36 in the lower-layer electrode 35 of the second embodiment of FIG. 7A with tapered corners. In such a case, each slit has the four corners, and the top left corner and the bottom right corner of the four corners are shaped described above in view of the upper-layer electrode fingers 25 that obliquely extend from top right to bottom left as illustrated. In this way, as illustrated in FIG. 11, the outline 40b of the lower-layer electrode finger 40 extending from the fixed line width portion 40a of the lower-layer electrode finger 40 to the expanded line width portion 41 is arranged to be in parallel with the outline 25b of the upper-layer electrode finger 25.

The rest of the structure of the third embodiment remains identical to that of the first and second embodiments.

In accordance with the present embodiment as well, the liquid crystal display device cuts down on the load capacitance in comparison with the known FFS liquid crystal display device, and the same advantages as those of the first and second embodiments are provided including reducing power consumption for driving and performing high-speed driving without difficulty.

In accordance with the second embodiment, the expanded portion 37 is provided near the intersection region 28 of the lower-layer electrode finger 36 and the upper-layer electrode finger 25, and is thus laterally exposed out of the outline of the upper-layer electrode finger 25. As a result, the in-plane electric field is generated near the intersection region 28 of the lower-layer electrode finger 36 and the upper-layer electrode finger 25 with the voltage applied. However, since the outline of the fixed line width portion of the lower-layer electrode finger 36 and the outline of the expanded portion 37 of the lower-layer electrode finger 36 are perpendicular to each other, these outlines are not parallel with the outlines of the upper-layer electrode finger 25. An in-plane electric field is at least generated near the intersection region 28, but the direction of the in-plane electric field in a plan view (an azimuth angle of the in-plane electric field) is different from that in other area. As a result, the liquid crystal molecules are disturbed in alignment direction, possibly decreasing transmittance.

In contrast, in accordance with the present embodiment, the outline 40b of the lower-layer electrode finger 40 extending from the fixed line width portion 40a of the lower-layer electrode finger 40 to the expanded line width portion 41 is arranged to be in parallel with the outline 25b of the upper-layer electrode finger 25. Since the in-plane electric field is aligned in azimuth angle with the in-plane electric field in the other area, the disturbance of the alignment of the liquid crystal molecules is reduced. The drop in transmittance is thus controlled. The present embodiment is implemented in the most effective way by arranging the outline 40b of the lower-layer electrode finger 40 in parallel with the outline 25b of the upper-layer electrode finger 25. The outline 40b of the lower-layer electrode finger 40 does not necessarily have to be arranged in parallel with the outline 25b of the upper-layer electrode finger 25. The increasing effect of transmittance in the second embodiment is provided by obliquely arranging the outline 40b of the lower-layer electrode finger 40 extending from the fixed line width portion 40a of the lower-layer electrode finger 40 to the expanded line width portion 41.

In accordance with the present embodiment, the effect of a misalignment between the lower-layer electrode 39 and the upper-layer electrode 20 becomes larger than that in the first and second embodiments. However, unlike the liquid crystal display device disclosed in PTL 3, a variation in the area of the overlapping region of the lower-layer electrode finger 39 and the upper-layer electrode 20 taking place in response to the misalignment is minimal in comparison with the area of the entire pixel. Therefore, a variation in the load capacitance caused by a misalignment is smaller than that in the related art.

### Fourth Embodiment

A fourth embodiment is described next with reference to FIG. 12 through FIG. 14.

The basic configuration of the liquid crystal display device of the present embodiment is identical to that of the first embodiment except for the structure of the lower-layer electrode.

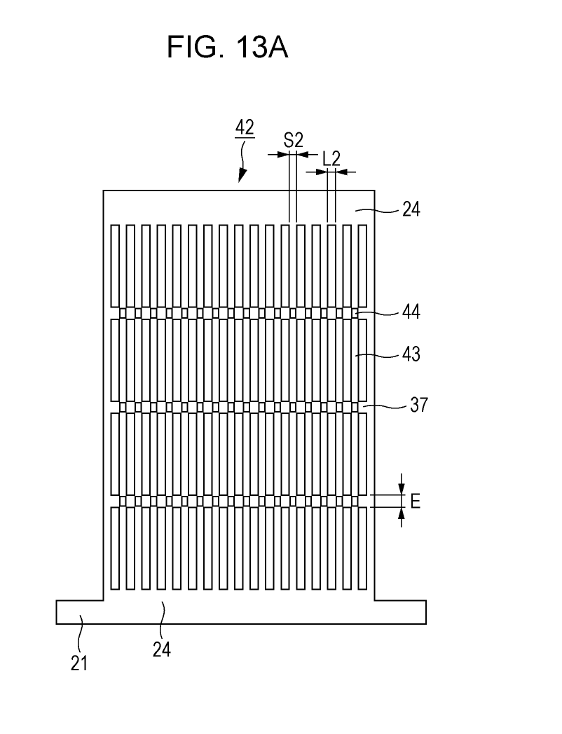

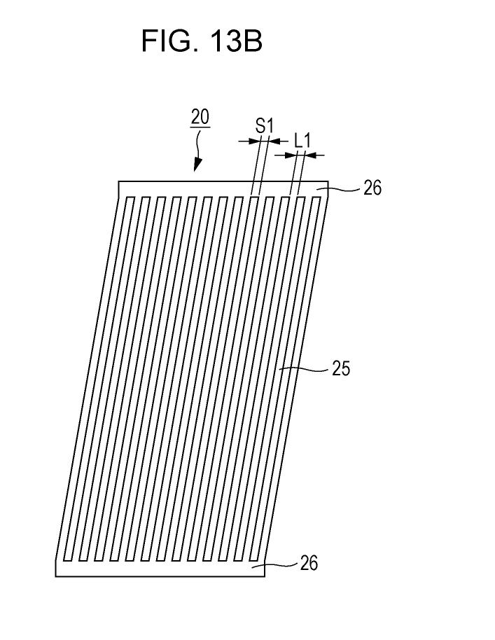

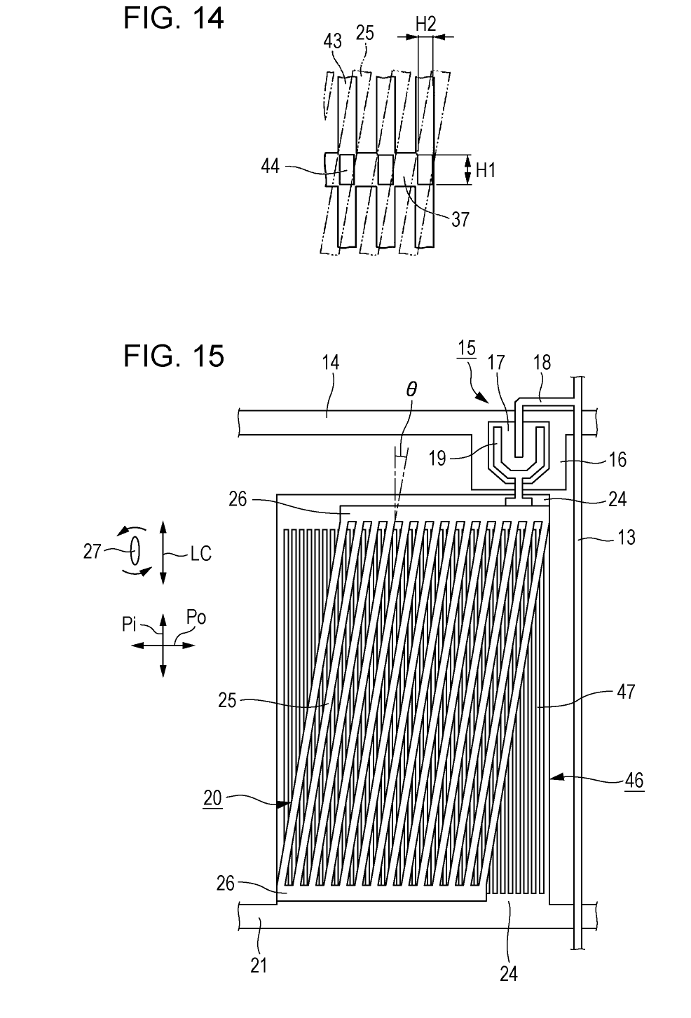

FIG. 12 is a plan view illustrating a single pixel in a liquid crystal display device of the present embodiment. FIG. 13A is a plan view of a lower-layer electrode. FIG. 13B is a plan view of an upper-layer electrode. FIG. 14 is an expanded view of intersection regions of the lower-layer electrode and the upper-layer electrode.

In FIG. 12 through FIG. 14, elements identical to those of the first embodiment in FIG. 1 through FIG. 3B are designated with the same reference numerals, and the discussion thereof is omitted herein.

In accordance with the second embodiment as illustrated in FIG. 8, the lower-layer electrode finger 36 intersects the upper-layer electrode finger 25, an area where the upper-layer electrode finger 25 covers the lower-layer electrode finger 36 (the intersection region 28) does not contribute to the alignment of the liquid crystal molecules but increases the load capacitance. In a lower-layer electrode 42 of the present embodiment, a rectangular aperture 44 is formed in the intersection region 28 by cutting away part of a lower-layer electrode finger 43 in the intersection region 28 of the lower-layer electrode finger 43 and the upper-layer electrode finger 25 as illustrated in FIG. 12 through FIG. 14. As an dimension example, a dimension H1 of the aperture 44 in the longitudinal direction of the lower-layer electrode finger 43 is 5 μm, and a dimension H2 of the aperture in a direction perpendicular to the longitudinal direction of the lower-layer electrode finger 43 is 3 μm. However, since the lower-layer electrode finger 43 has to be electrically connected to the expanded portion 37, the expanded portion 37 is not completely isolated from the lower-layer electrode finger 43 regardless of the arrangement of the aperture 44, and the expanded portion 37 is partially connected to the lower-layer electrode finger 43.

The rest of the structure remains unchanged from that in the first and second embodiments.

In accordance with the present embodiment as well, the liquid crystal display device cuts down on the load capacitance in comparison with the known FFS liquid crystal display device, and the same advantages as those of the first through third embodiments are provided including reducing power consumption for driving and performing high-speed driving without difficulty. In comparison with the second embodiment in particular, the liquid crystal display device cuts down on the load capacitance without changing the generation state of the in-plane electric field and thus without reducing transmittance.

The shape of the aperture 44 is rectangular in the above example. The aperture 44 is not limited to a rectangular shape, and may be changed in shape as appropriate. The dimensions of the aperture 44 may also be changed as appropriate. In the present embodiment, the aperture 44 is arranged in the intersection region 28 in the electrode structure of the second embodiment. Alternatively, the aperture may be arranged in the intersection region in the electrode structure of the third embodiment.

### Fifth Embodiment

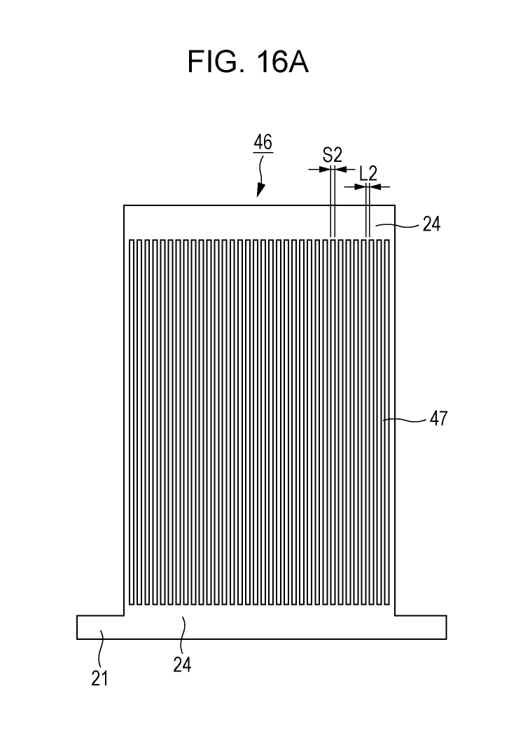

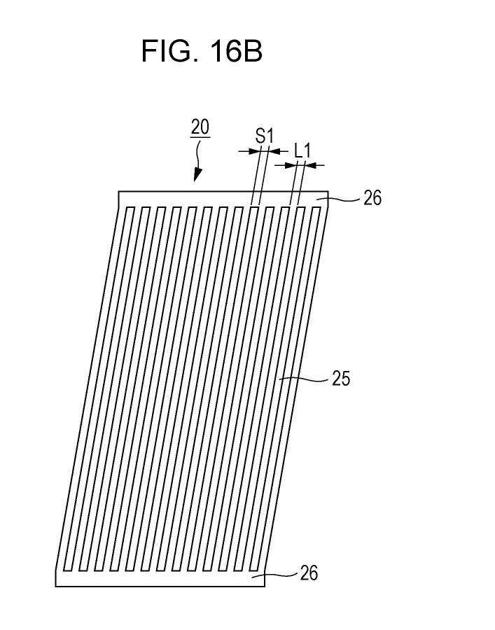

A fifth embodiment of the present invention is described next with reference to FIG. 15, FIG. 16A, and FIG. 16B.

The basic configuration of the liquid crystal display device of the present embodiment is identical to that of the first embodiment except for the structure of the lower-layer electrode.

FIG. 15 is a plan view illustrating a single pixel in the liquid crystal display device of the present embodiment. FIG. 16A is a plan view of a lower-layer electrode. FIG. 16B is a plan view of only an upper-layer electrode.

In FIG. 15, FIG. 16A, and FIG. 16B, elements identical to those of the first embodiment in FIG. 1 through FIG. 3B are designated with the same reference numerals, and the discussion thereof is omitted herein.

In the first through fourth embodiments, L1/S1 of the upper-layer electrode finger is 3/3 μm, and L2/S2 of the lower-layer electrode finger is 3/3 μm. The sum of the line width L1 and the line spacing S1 of the upper-layer electrode fingers (L1+S1) is a pitch of the upper-layer electrode fingers, and the sum of the line width L2 and the line spacing S2 of the lower-layer electrode fingers (L2+S2) is a pitch of the lower-layer electrode fingers. Therefore, in accordance with the first through fourth embodiments, the pitch of the upper-layer electrode fingers is equal to the pitch of the lower-layer electrode fingers.

In contrast, in the present embodiment, a relationship L1+S1>L2+S2 holds as illustrated in FIG. 15, FIG. 16A and FIG. 16B. More specifically, a pitch of lower-layer electrode fingers 47 in a lower-layer electrode 46 is set to be smaller than a pitch of the upper-layer electrode fingers 25. More specifically, as a dimension example, L1/S1 of the upper-layer electrode fingers 25 is 3/3 w, and L2/S2 of the lower-layer electrode fingers 47 is 1.5/1.5 μm. In the dimension example, the pitch of the lower-layer electrode fingers 47 is set to be half the pitch of the upper-layer electrode fingers 25. In comparison with the first embodiment, the pitch of the lower-layer electrode fingers 47 is merely set to be half the pitch of the lower-layer electrode fingers 23 of the first embodiment, and the lower-layer electrode fingers 47 remains unchanged in shape from the lower-layer electrode finger 23 of the first embodiment. The rest of the structure remains unchanged from the first embodiment.

In accordance with the present embodiment as well, the liquid crystal display device greatly cuts down on the load capacitance in comparison with the known FFS liquid crystal display device, and the same advantages as those of the first embodiment are provided including reducing power consumption for driving and performing high-speed driving without difficulty.

Particularly in accordance with the present embodiment, the pitch L2+S2 of the lower-layer electrode fingers 47 is set to be smaller, and the line width L2 of the lower-layer electrode finger 47 is also narrowed. In other words, the lower-layer electrode fingers 47, each having a narrower line width, are densely arranged in comparison with the first embodiment. In this way, there is no area where each of the lower-layer electrode fingers 47 is fully covered with the upper-layer electrode fingers 25 if viewed from a direction perpendicular to the lower-layer electrode fingers 47. There is no area where the upper-layer electrode fingers 25 are adjacent with no lower-layer electrode fingers 47 interposed therebetween. As a result, the alignment of the liquid crystal molecules is stabilized over the entire pixel region, and a high transmittance is achieved. Also, in the above example, no variation occurs in the load capacitance in response to a misalignment.

In the dimension example of the present embodiment, the line width L2 is set to be equal to the line spacing S2 in the lower-layer electrode finger 47. It is sufficient enough if the condition that the pitch (L2+S2) of the lower-layer electrode fingers 47 is smaller than the pitch (L1+S1) of the upper-layer electrode fingers 25 is satisfied. The line width L2 may be different from the line spacing S2 in the lower-layer electrode fingers 47. The line width L2 may be larger than the line spacing S2 in the lower-layer electrode fingers 47 or may be smaller than the line spacing S2 in the lower-layer electrode fingers 47.

### Sixth Embodiment

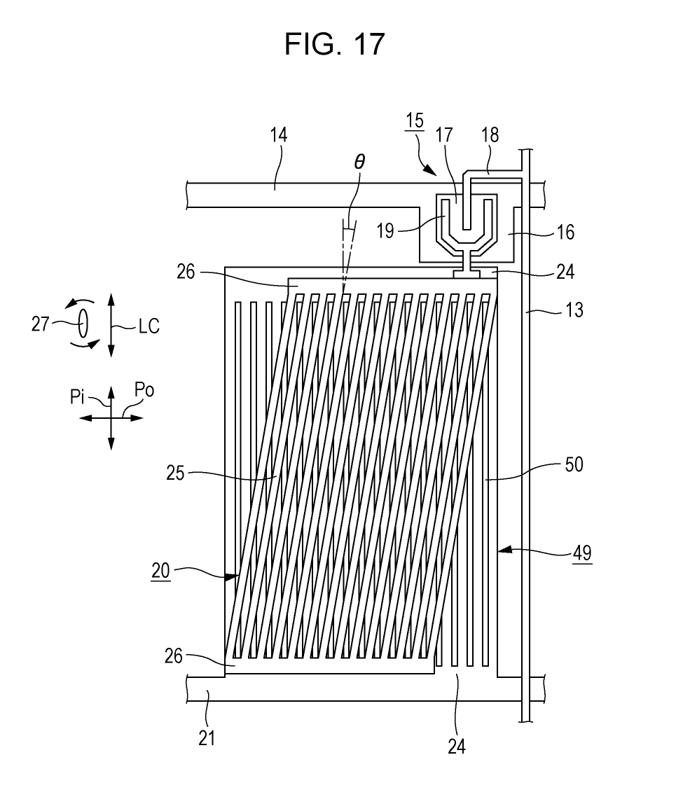

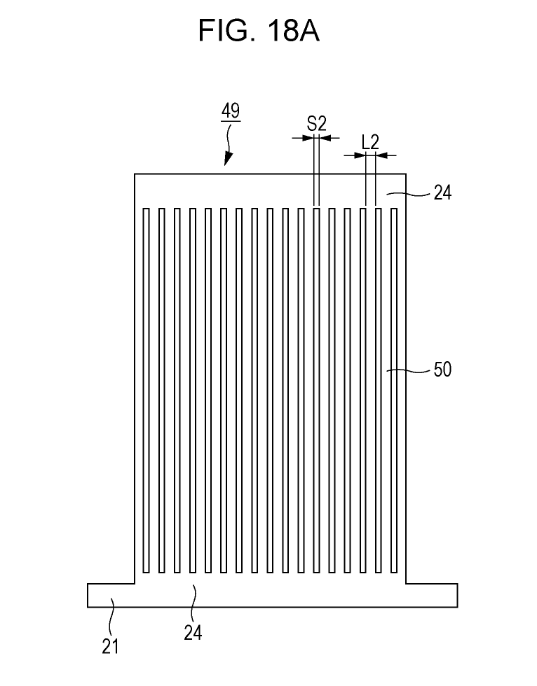

A sixth embodiment of the present invention is described next with reference to FIG. 17, FIG. 18A, and FIG. 18B.

The basic configuration of the liquid crystal display device of the present embodiment is identical to that of the first embodiment except for the structure of the lower-layer electrode.

FIG. 17 is a plan view illustrating a single pixel in a liquid crystal display device of the present embodiment. FIG. 18A is a plan view of only a lower-layer electrode. FIG. 18B is a plan view of only an upper-layer electrode.

In FIG. 17, FIG. 18A, and FIG. 18B, elements identical to those of the first embodiment in FIG. 1 through FIG. 3B are designated with the same reference numerals, and the discussion thereof is omitted herein.

As described above with reference to the fifth embodiment, the pitch of the upper-layer electrode fingers is set to be equal to the pitch of the lower-layer electrode fingers in the first through fourth embodiments. In accordance with the present embodiment, the pitch of the upper-layer electrode fingers is also set to be equal to the pitch of the lower-layer electrode fingers, and the relationship L1+S1=L2+S2 holds. As illustrated in FIG. 17, FIG. 18A and FIG. 18B, a lower-layer electrode 49 of the present embodiment is different from the lower-layer electrode of the first embodiment in that the line width L1 of the upper-layer electrode finger is not equal to the line width L2 of the lower-layer electrode finger but the line width L2 of a lower-layer electrode finger 50 is set to be larger than the line width L1 of the upper-layer electrode finger 25. More specifically, as a dimension example, L1/S1 of the upper-layer electrode fingers 25 is 3/3 μm, and L2/S2 of the lower-layer electrode fingers 50 is 4/2 μm. In comparison with the first embodiment, the line width of the lower-layer electrode finger 50 is set to be larger than the line width of the lower-layer electrode finger 23 in the first embodiment. The shape of the lower-layer electrode finger 50 remains the same as the lower-layer electrode in the first embodiment. The rest of the structure also remains unchanged from that of the first embodiment.

In accordance with the present embodiment as well, the liquid crystal display device greatly cuts down on the load capacitance in comparison with the known FFS liquid crystal display device, and the same advantages as those of the first embodiment are provided including reducing power consumption for driving and performing high-speed driving without difficulty.

In the present embodiment as in the fifth embodiment, there is no area where each of the lower-layer electrode fingers 50 is fully covered with the upper-layer electrode finger 25 if viewed from a direction perpendicular to the lower-layer electrode fingers 50. There is no area where the upper-layer electrode fingers 25 are adjacent to each other with no lower-layer electrode fingers 50 interposed therebetween. As a result, the alignment of the liquid crystal molecules is stabilized over the entire pixel region, and a high transmittance is achieved. The reduction effect of the load capacitance decreases in the present embodiment because the widening of the lower-layer electrode fingers 50 increases the area of an intersection region 51 between the lower-layer electrode finger 50 and the upper-layer electrode finger 25. However, the load capacitance is still sufficiently reduced in comparison with the known FFS liquid crystal display device.

### Seventh Embodiment

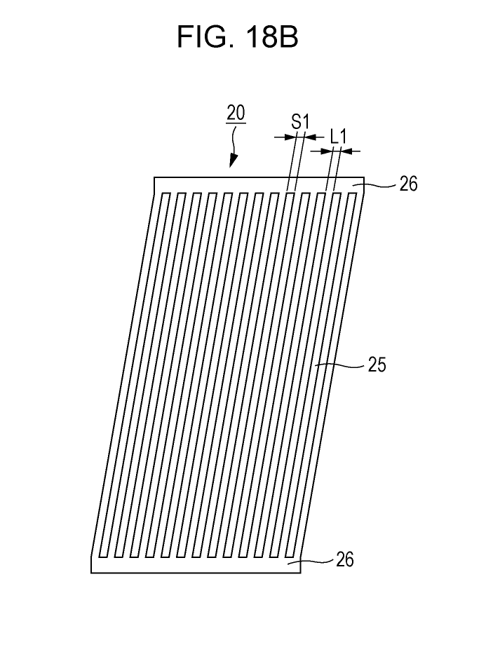

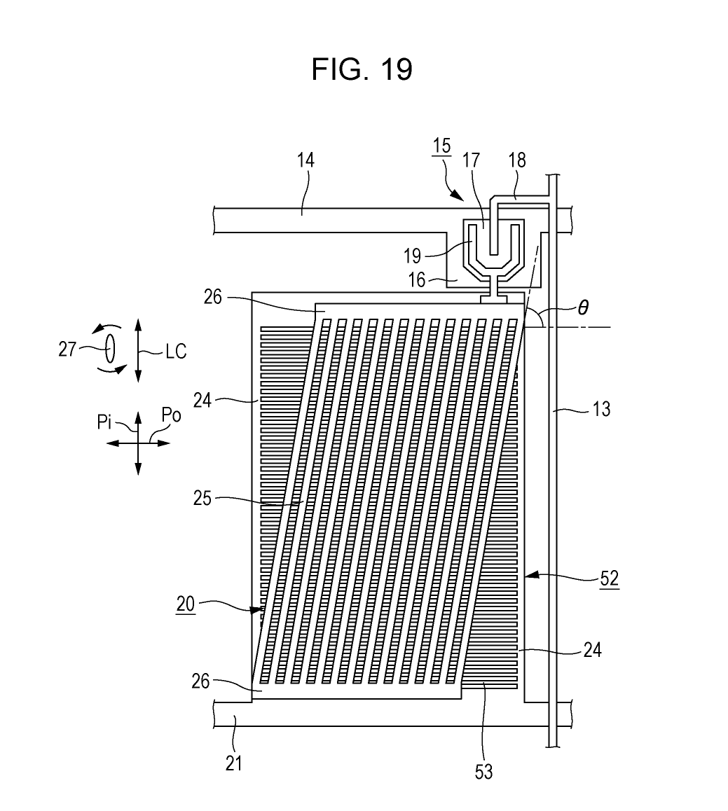

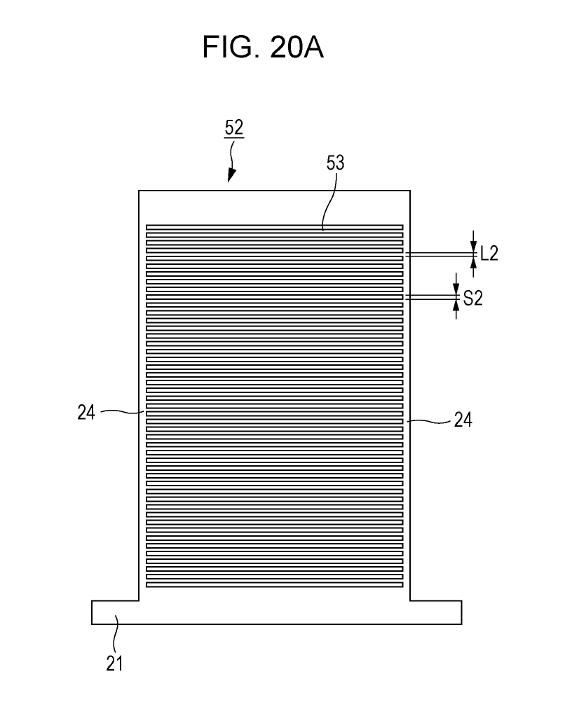

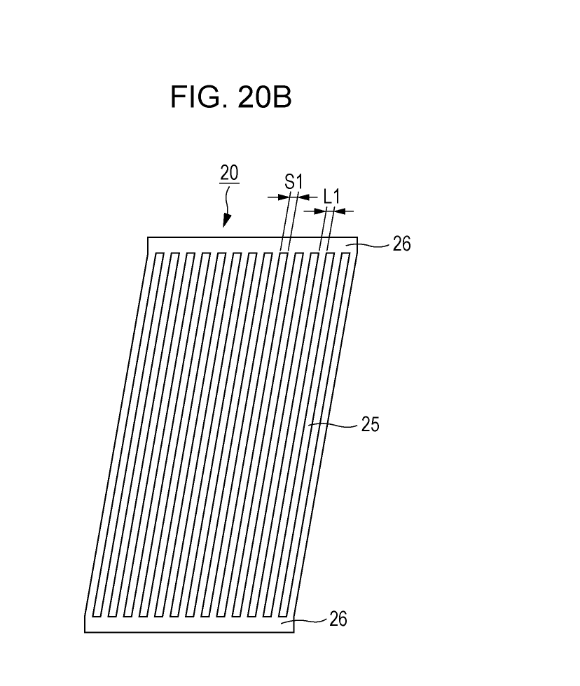

A seventh embodiment of the present invention is described next with reference to FIG. 19, FIG. 20A, and FIG. 20B.

The basic configuration of the liquid crystal display device of the present embodiment is identical to that of the first embodiment except for the structure of the lower-layer electrode.

FIG. 19 is a plan view illustrating a single pixel in a liquid crystal display device of the present embodiment. FIG. 20A is a plan view of only a lower-layer electrode. FIG. 20B is a plan view of only an upper-layer electrode.

In FIG. 19, FIG. 20A, and FIG. 20B, elements identical to those of the first embodiment in FIG. 1 through FIG. 3B are designated with the same reference numerals, and the discussion thereof is omitted herein.

In accordance with the first though sixth embodiments, the lower-layer electrode is arranged so that the longitudinal direction of the lower-layer electrode fingers is in parallel with the source bus line. In contrast, in accordance with the present embodiment as illustrated in FIG. 19 and FIG. 20A, a lower-layer electrode 52 is rotated by 90 degrees in a plane of the TFT array substrate 6 from the layout of the above-described embodiments so that the longitudinal direction of the lower-layer electrode finger 53 is perpendicular to the source bus line 13. Therefore, the upper-layer electrode finger 25 intersects a lower-layer electrode finger 53 at an angle of 80 degrees (a crossing angle θ=80 degrees).

As in the fifth embodiment, the pitch L2+S2 of the lower-layer electrode fingers 53 is set to be smaller than the pitch L1+S1 of the upper-layer electrode fingers 25. More specifically, as a dimension example, L1/S1 of the upper-layer electrode fingers 25 is 3/3 μm, and L2/S2 of the lower-layer electrode fingers 53 is 1.5/1.5 μm. In the dimension example, the pitch L2+S2 of the lower-layer electrode fingers 53 is set to be half the pitch L1+S1 of the upper-layer electrode finger 25.

The rest of the structure remains unchanged from that of the first embodiment.

In accordance with the present embodiment as well, the liquid crystal display device cuts down on the load capacitance in comparison with the known FFS liquid crystal display device, and the same advantages as those of the first embodiment are provided including reducing power consumption for driving and performing high-speed driving without difficulty.

In the present embodiment as in the fifth embodiment, there is no area where each of the lower-layer electrode fingers 53 is fully covered with the upper-layer electrode fingers 25. There is no area where the upper-layer electrode fingers 25 are adjacent with no lower-layer electrode fingers 53 interposed therebetween. As a result, the alignment of the liquid crystal molecules is stabilized over the entire pixel region, and a high transmittance is achieved. Also, in the above example, no variation occurs in the load capacitance in response to a misalignment.

In the dimension example of the present embodiment, the line width L2 is set to be equal to the line spacing S2 in the lower-layer electrode fingers 53. The line width L2 may be different from the line spacing S2 in the lower-layer electrode fingers 53. The line width L2 may be larger than the line spacing S2 in the lower-layer electrode finger 53 or may be smaller than the line spacing S2 in the lower-layer electrode finger 53.

### EXAMPLES

The inventors of the invention conducted simulation tests on the liquid crystal display devices of the embodiments in terms of a transmittance distribution, and an electric field distribution of each liquid crystal display device, an alignment state of liquid crystal molecules, and a pixel capacitance, and then verified the advantageous effects of the present invention. The results of the simulation tests are described below.

Liquid crystal display device design simulator “LCD Master 3D” (manufactured by SHINTEC CO., LTD.) was used as a simulation tool. Used as parameters common to all examples were a liquid crystal layer thickness d=3.5 μm, refractive index anisotropy Δn of the liquid crystal layer Δn=0.1, a dielectric constant ∈1 of the liquid crystal molecules in the long axis ∈1=14.9, a dielectric constant ∈2 of the liquid crystal molecules in the short axis ∈2=4.0, a pre-tilt angle of the liquid crystal layer=0 degree, a film thickness t of the insulating film between the upper-layer electrode and the lower-layer electrode t=0.5 μm, and a dielectric constant ∈d of the insulating film ∈d=6.

### First Example

The liquid crystal display device of the first embodiment of FIG. 2 is a first example.

The pattern of the upper-layer electrode and the lower-layer electrode of FIG. 2 are a repetitive unit pattern that is periodically repeated. If the simulation test is performed on the unit pattern, it is readily understood that the simulation results of the transmittance distribution, the electric field distribution, the alignment state of the liquid crystal, and the like are also repetitive.

This technique is common to all the following examples.

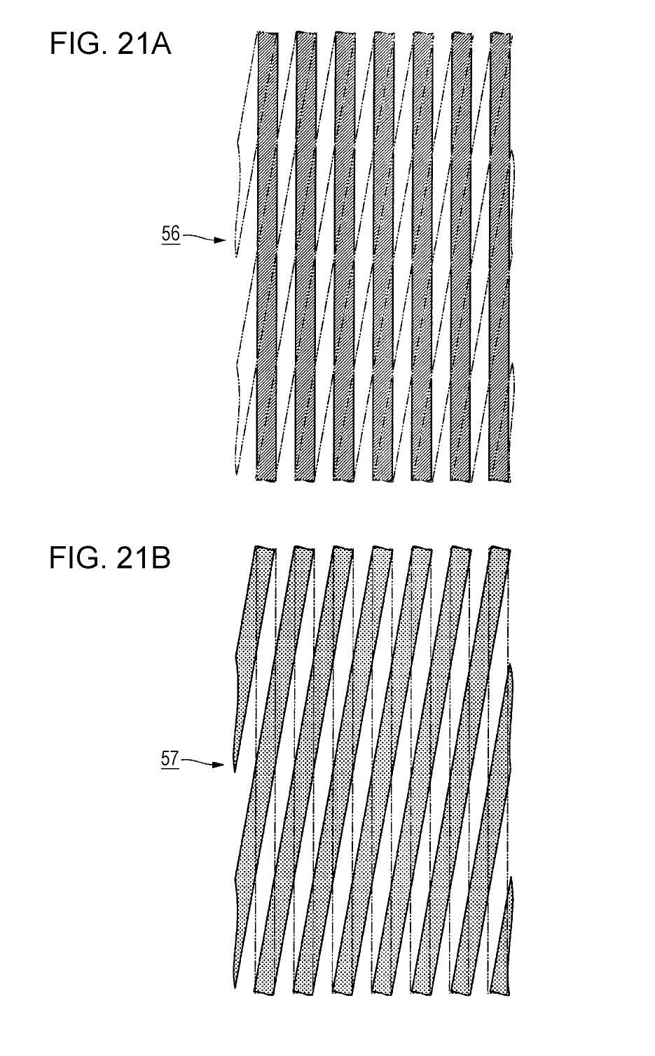

In the first example, only an electrode pattern of part of the pixel region is extracted as a unit pattern as illustrated in FIG. 21A and FIG. 21B. FIG. 21A illustrates a lower-layer electrode pattern 56 used in the simulation test, and FIG. 21B illustrates an upper-layer electrode pattern 57.

In the known FFS liquid crystal display device, the area of the overlapping region between the upper-layer electrode and the lower-layer electrode is 50% of the entire electrode formation region while in the first example the area of the overlapping region between the upper-layer electrode and the lower-layer electrode is reduced to 25%.

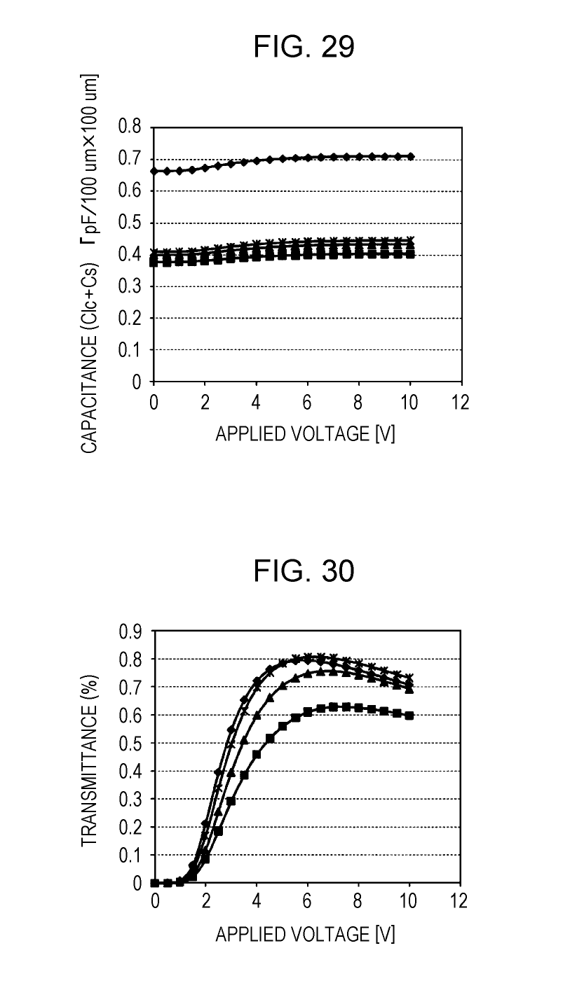

FIG. 29 is a plot of a relationship between an applied voltage and a pixel capacitance (Clc+Cs). The relationship between the applied voltage and the pixel capacitance (Clc+Cs) in the first example is represented by solid squares. The relationship between the applied voltage and the pixel capacitance (Clc+Cs) in the known FFS is represented by solid diamonds. The horizontal axis in FIG. 29 represents the applied voltage [V]. The vertical axis in FIG. 29 represents the pixel capacitance [pF/100 μm×100 μm]. The electrode design is different from example to example, and the area to be calculated is different from example to example. For this reason, the pixel capacitance is calculated after converting the area into 100×100 μm².

As illustrated in FIG. 29, the relationship between the applied voltage and the pixel capacitance (Clc+Cs) in a second example is represented by solid triangles. If calculated from the plot of the first example of FIG. 29, the pixel capacitance is reduced to 57% in the first example with respect to the known FFS type. Although the area of the overlapping region of the upper-layer electrode and the lower-layer electrode is reduced to 50% of the known FFS type, the pixel capacitance also includes a capacitance of a region other than the overlapping region, and the reduction rate is smaller than that. It is understood that with this result, the pixel capacitance is still reduced by 43% in comparison with the known FFS type.

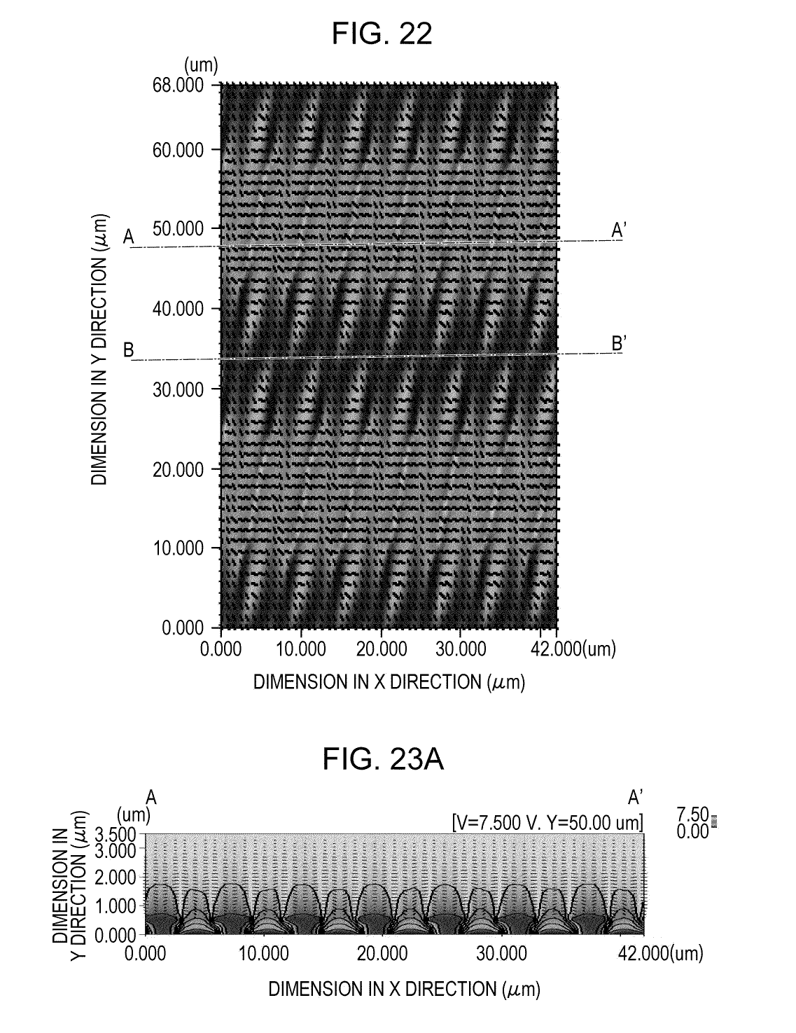

FIG. 22 illustrates the transmittance distribution in the patterns illustrated in FIG. 21A and FIG. 21B.

Referring to FIG. 22, a whitish portion indicates an area where transmittance is high with an electric field applied, and a blackish portion indicates an area where transmittance is low with the electric field applied. The liquid crystal display device of the present example operates in a normally black mode, and presents a white display with the electric field applied. Therefore, the whitish portion indicates the area where the alignment state of the liquid crystal molecules is good, while the blackish portion indicates the area where the alignment state of the liquid crystal molecules is not good.

As illustrated in FIG. 22, the area expanding near a location quarter way down the transmittance distribution of FIG. 22 (the area along A-A′ line) from top the top looks whitish. The area is stable in the alignment of the liquid crystal molecules, and particularly high in transmittance.

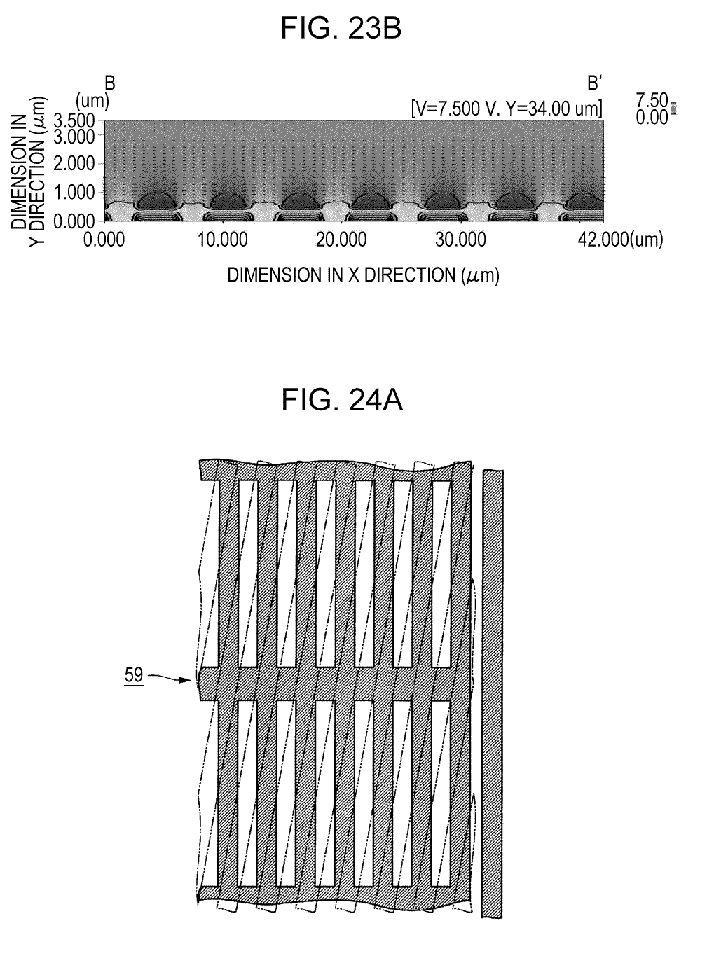

FIG. 23A is a sectional view of the liquid crystal layer corresponding to this area, and illustrates an equipotential line and directors of the liquid crystal molecules.

The shape of the equipotential line revealed that the in-plane electric field was sufficiently generated. FIG. 23A also revealed that the liquid crystal molecules were sufficiently aligned. On the other hand, since the upper-layer electrode and the lower-layer electrode do not overlap each other, the load capacitance becomes smaller.

The area expanding near a location half way down the transmittance distribution of FIG. 22 (the area along B-B′ line) from the top looks blackish. The area is not good in terms the alignment of the liquid crystal molecules, and particularly low in transmittance.

FIG. 23B is a sectional view of the liquid crystal layer corresponding to this area, and illustrates an equipotential line and directors of the liquid crystal molecules.

The shape of the equipotential line revealed that the lower-layer electrode was shielded in potential by the upper-layer electrode, and that no in-plane electric field was generated. It was also revealed that the liquid crystal molecules were not aligned. On the other hand, a high load capacitance is caused by the overlapping between the upper-layer electrode and the lower-layer electrode.

Transmittance at the electrode intersection region is increased in the second and subsequent examples.

### Second Example

The liquid crystal display device of the second embodiment illustrated in FIG. 6 is the second example.

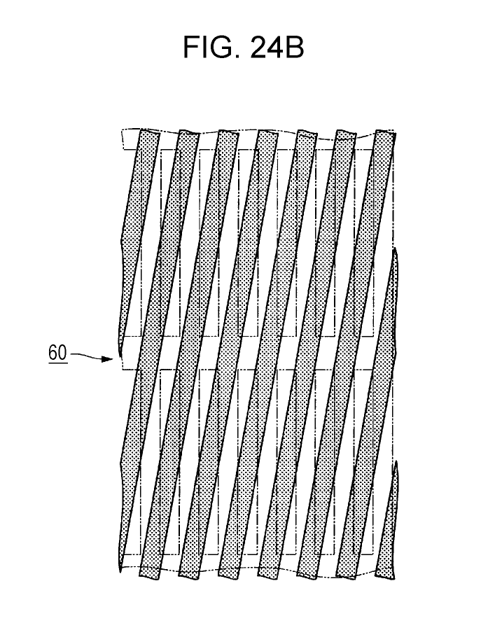

In the second example, FIG. 24A illustrates a lower-layer electrode pattern 59 used in the simulation test, and FIG. 24B illustrates an upper-layer electrode pattern 60.

In the known FFS liquid crystal display device, the area of the overlapping region of the upper-layer electrode and the lower-layer electrode is 50% of the entire electrode formation region while the area of the overlapping region of the upper-layer electrode and the lower-layer electrode was reduced to 25% in the second example as in the first example.

The relationship between the applied voltage and the pixel capacitance (Clc+Cs) in the second example is represented by solid triangles. If calculated from the plot of the second example of FIG. 29, the pixel capacitance is reduced to 61% in the second example with respect to the known FFS type. Although the area of the overlapping region of the upper-layer electrode and the lower-layer electrode remains unchanged from that in the first example, the use of the expanded portion slightly increases the load capacitance responsive to the in-plane electric field. For this reason, the reduction effect of the pixel capacitance is decreased to 61% from 57% of the first example with respect to the known FFS liquid crystal display device. However, it was understood that the pixel capacitance was still reduced by 39% in comparison with the known FFS type.

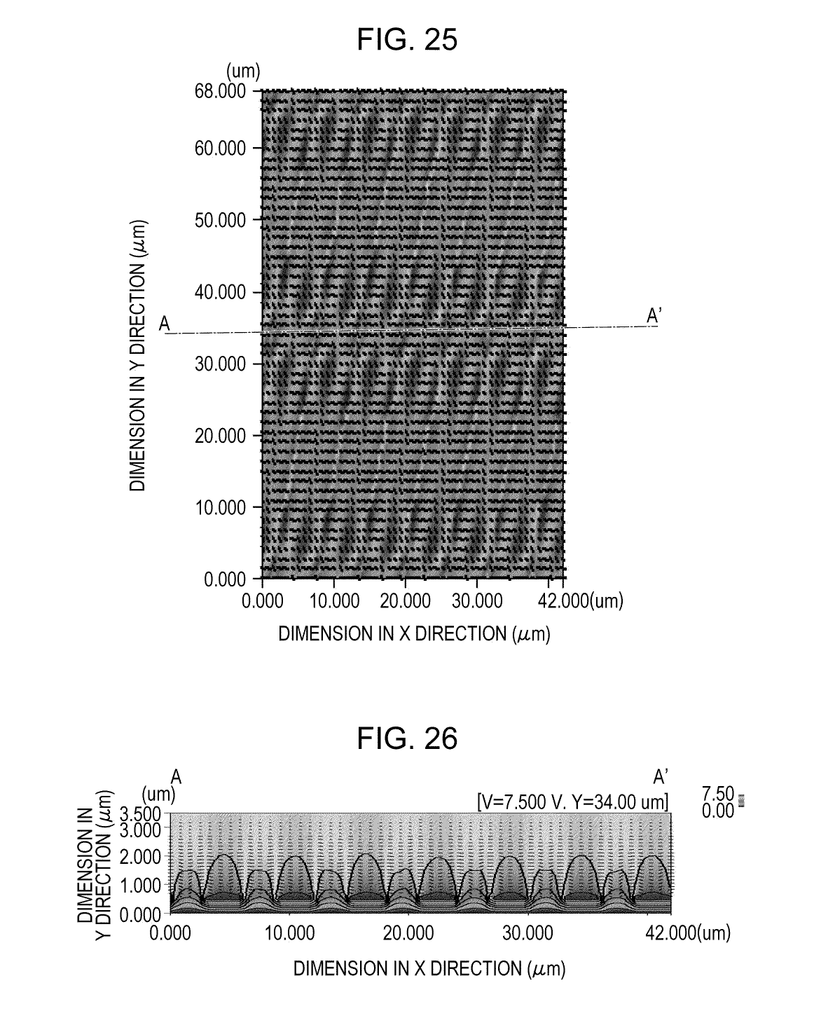

FIG. 25 illustrates a transmittance distribution within the patterns of FIG. 24A and FIG. 24B.

The area expanding near a location half way down the transmittance distribution chart of FIG. 25 (the area along A-A′ line) from the top looks whitish while the corresponding area of the first example in FIG. 22 looks blackish. This revealed that transmittance was increased.

FIG. 26 is a sectional view of the liquid crystal layer corresponding to this area.

The use of the expanded portion exposes the lower-layer electrode laterally out of the outline of the upper-layer electrode. In comparison with the first example of FIG. 23B, it was understood that the in-plane electric field was sufficiently generated, and that the liquid crystal molecules are sufficiently aligned.

However, since the azimuth angle of the directors of the liquid crystal molecules is disturbed at the outline of the expanded portion, there is still room for an increase in transmittance.

A third example described next is intended to increase transmittance.

### Third Example

The liquid crystal display device of the third embodiment illustrated in FIG. 9 is the third example.

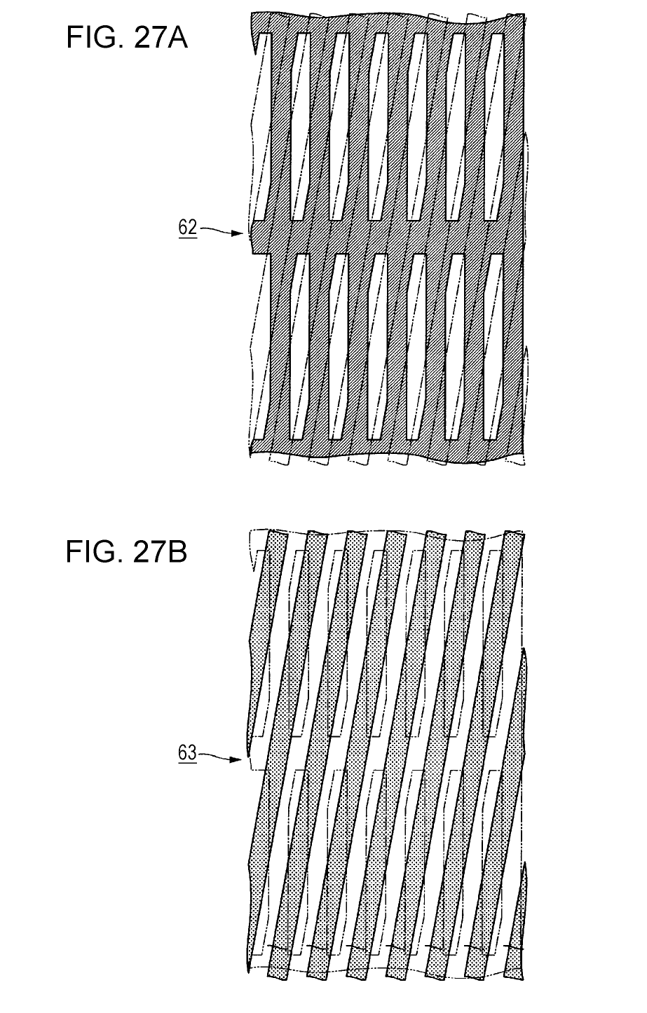

In the third example, FIG. 27A illustrates a lower-layer electrode pattern 62 used in the simulation test, and FIG. 27B illustrates an upper-layer electrode pattern 63.

In the known FFS liquid crystal display device, the area of the overlapping region of the upper-layer electrode and the lower-layer electrode is 50% of the entire electrode formation region while the area of the overlapping region of the upper-layer electrode and the lower-layer electrode was reduced to 25% in the third example as in the first and second examples.

As illustrated in FIG. 29, the relationship between the applied voltage and the pixel capacitance (Clc+Cs) in the third example is represented by asterisk symbols. If calculated from the plot of the third example of FIG. 29, the pixel capacitance is reduced to 63% in the third example with respect to the known FFS type. Although the area of the overlapping region of the upper-layer electrode and the lower-layer electrode remains unchanged from that of the first and second examples, the lower-layer electrode finger is expanded with the outline thereof becoming parallel with the outline of the upper-layer electrode finger in addition to the use of the expanded portion. As a result, the load capacitance is further increased in response to the in-plane electric field. For this reason, the reduction effect of the pixel capacitance is further reduced to 63% from 61% in the second example with reference to the known FFS type. However, it was understood that the pixel capacitance was still reduced by 37% in comparison with the known FFS type.

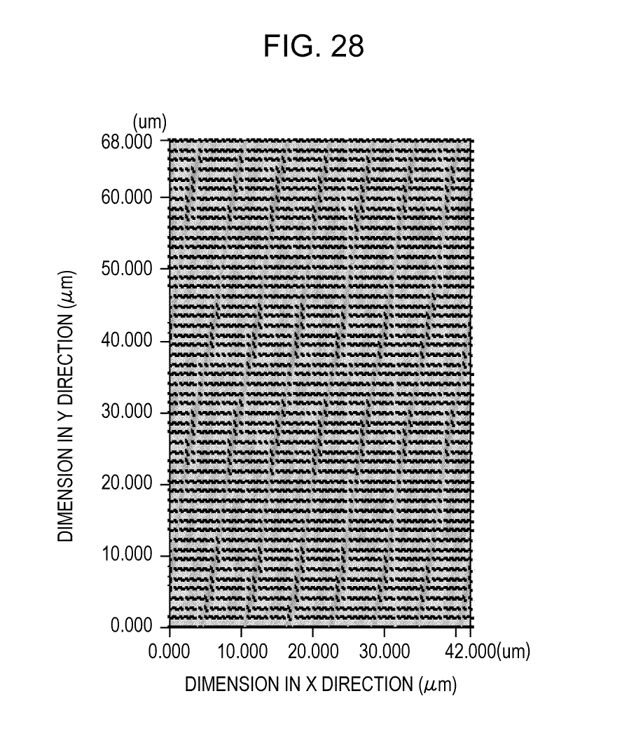

FIG. 28 illustrates the transmittance distribution in the patterns illustrated in FIG. 27A and FIG. 27B.

With reference to the transmittance distribution chart of FIG. 28, the area on both sides of a location half way down the transmittance distribution chart of FIG. 25 from the top looks blackish while the corresponding area in the transmittance distribution chart in FIG. 28 looks whitish. This revealed that transmittance is even more increased.

FIG. 30 is a plot of a relationship between an applied voltage and transmittance in the first through third examples. The relationship between the applied voltage and the transmittance in the first example is represented by solid squares. The relationship between the applied voltage and the transmittance in the second example is represented by solid triangles. The relationship between the applied voltage and the transmittance in the third example is represented by asterisk symbols. The relationship between the applied voltage and the transmittance in the known FFS type is represented by solid diamonds. The horizontal axis in FIG. 30 represents the applied voltage [V]. The vertical axis in FIG. 30 represents the transmittance [%]. However, note that the transmittance here does not includes that of the polarizers, and is only the transmittance of the liquid crystal cell alone.

The calculation of the plot of FIG. 30 revealed that the transmittance of the first example was reduced by 20% with respect to the transmittance in the FFS type, that the transmittance of the second example was reduced by 5% with respect to the transmittance in the FFS type, and that the transmittance of the third example was reduced by 3% with respect to the transmittance in the FFS type. In this way, the improved electrode design reduces the pixel capacitance greatly, and results in the transmittance at almost the same level as the transmittance in the FFS type.

Table 1 lists the calculation results of the pixel capacitance and transmittance in the first through third examples.

TABLE 1

| | Pixel capacitance | |
|---|---|---|
| | (Clc + Cs) | Transmittance |
| First example | −43% | −20% |
| Second example | −39% | −5% |
| Third example | −37% | +3% |

### Fourth Example

Next, the liquid crystal display device of the fourth embodiment illustrated in FIG. 12 is a fourth example.

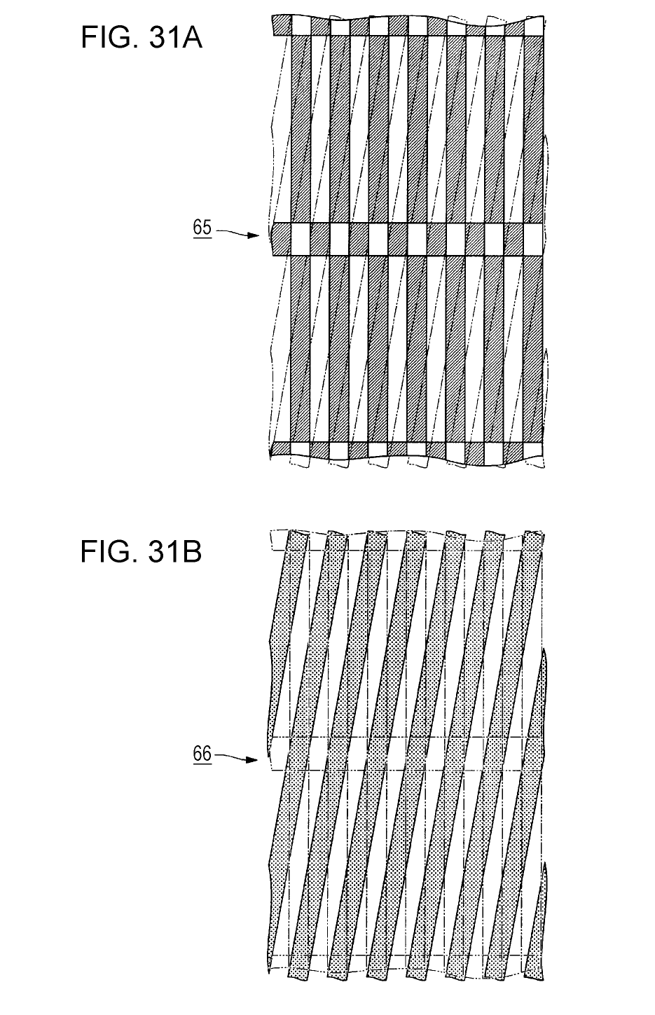

In the fourth example, FIG. 31A illustrates a lower-layer electrode pattern 65 used in the simulation test, and FIG. 31B illustrates an upper-layer electrode pattern 66.

In the known FFS liquid crystal display device, the area of the overlapping region of the upper-layer electrode and the lower-layer electrode is 50% of the entire electrode formation region while the area of the overlapping region of the upper-layer electrode and the lower-layer electrode was reduced to 17.5% in the fourth example by arranging the aperture in the intersection region of the upper-layer electrode finger and the lower-layer electrode finger.

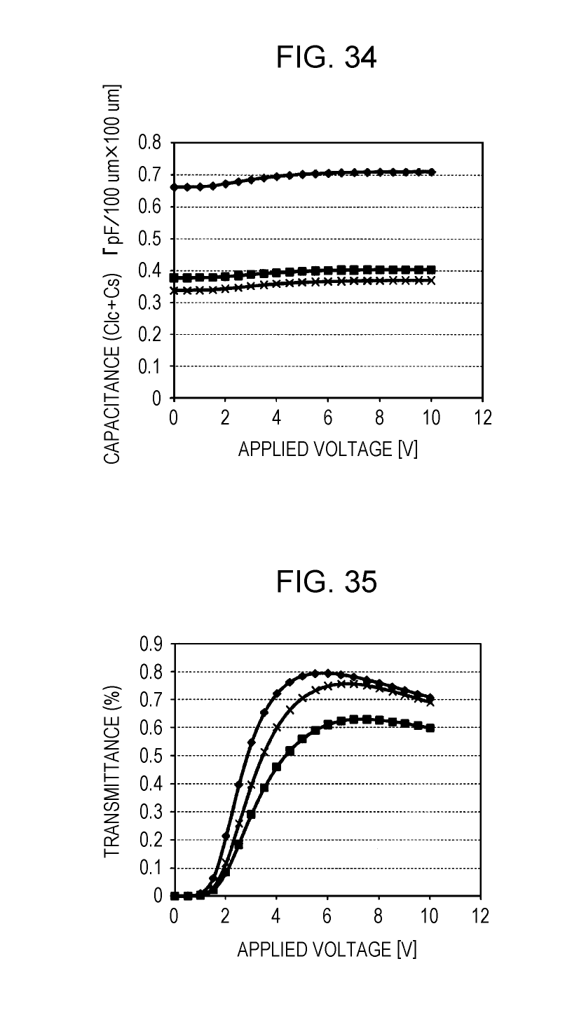

FIG. 34 is a plot of a relationship between an applied voltage and a pixel capacitance (Clc+Cs). The relationship between the applied voltage and the pixel capacitance (Clc+Cs) in the fourth example is represented by letters X. The relationship between the applied voltage and the pixel capacitance (Clc+Cs) in the first example is represented by solid squares. The relationship between the applied voltage and the pixel capacitance (Clc+Cs) in the known FFS is represented by solid diamonds. The horizontal axis in FIG. 34 represents the applied voltage [V]. The vertical axis in FIG. 34 represents the pixel capacitance [pF/100 μm×100 μm].

If calculated from the plot of the fourth example of FIG. 34, the pixel capacitance was reduced to 52% in the fourth example with respect to the known FFS type. Since the area of the overlapping region of the upper-layer electrode and the lower-layer electrode is reduced more than in the above-described examples, the reduction effect of the pixel capacitance was improved to 52% from 61% of the second example with respect to the FFS type. A maximum reduction effect is achieved in the present example among the examples described heretofore.

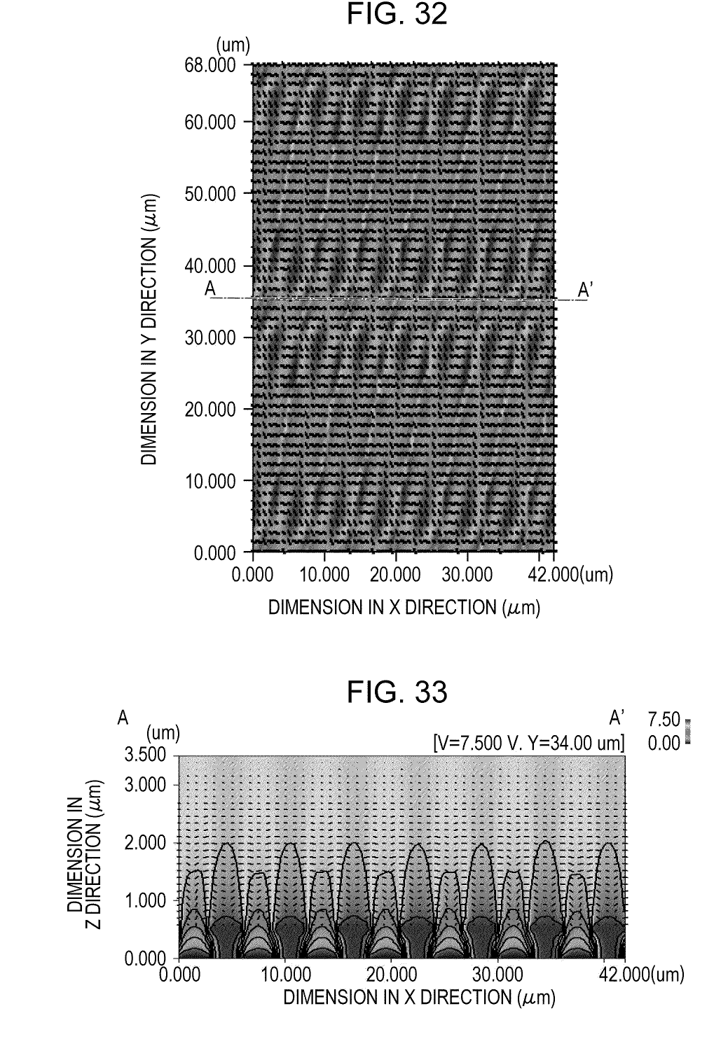

FIG. 32 illustrates the transmittance distribution in the patterns illustrated in FIG. 31A and FIG. 31B.

The transmittance is generally as good as in the second example of FIG. 25.

FIG. 33 is a sectional view of the liquid crystal layer at a location half way down the transmittance distribution chart of FIG. 32 from the top (the area along A-A′ line).

The fourth example has almost the same tendency as the second example of FIG. 26 in that the in-plane electric field is sufficiently generated and that the liquid crystal molecules are sufficiently aligned.

FIG. 35 is a plot of a relationship between an applied voltage and transmittance in the first through fourth examples. The relationship between the applied voltage and the transmittance in the first example is represented by solid squares. The relationship between the applied voltage and the transmittance in the fourth example is represented by letters X. The relationship between the applied voltage and the transmittance in the known FFS type is represented by solid diamonds. The horizontal axis in FIG. 35 represents the applied voltage [V]. The vertical axis in FIG. 35 represents the transmittance [%]. However, the transmittance here does not includes that of the polarizers, and is only the transmittance of the liquid crystal cell alone.

The calculation of the plot of FIG. 35 revealed that the transmittance of the first example was reduced by 20% with respect to the transmittance in the FFS type, and that the transmittance of the fourth example was reduced by 5% with respect to the transmittance in the FFS type. The transmittance of the fourth example is at the same level as the transmittance of the second example.

In this way, the improved electrode design reduces the pixel capacitance greatly, and results in the transmittance at almost the same level as the transmittance in the FFS type.

Table 2 lists the calculation results of the pixel capacitance and transmittance in the first and fourth examples.

TABLE 2

| | Pixel capacitance | Transmittance |
|---|---|---|
| First example | −43% | −20% |
| Fourth example | −48% | −5% |

### Fifth Example

Next, the liquid crystal display device of the fifth embodiment illustrated in FIG. 15 is a fifth example.

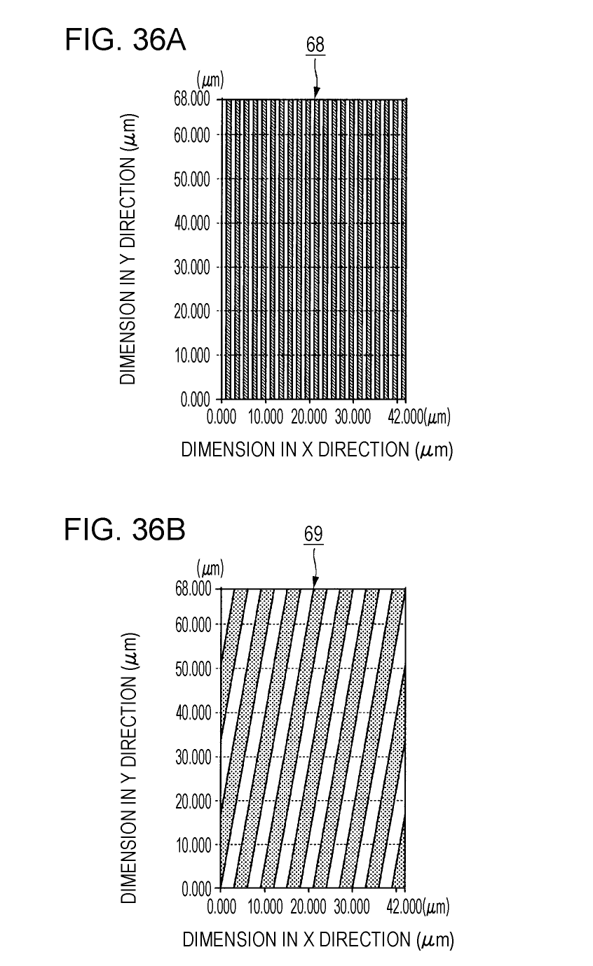

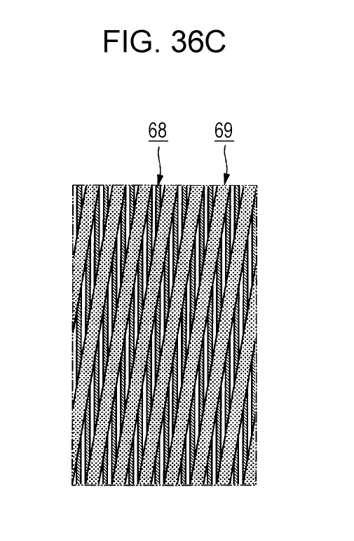

In the fifth example, FIG. 36A illustrates a lower-layer electrode pattern 68 used in the simulation test, FIG. 36B illustrates an upper-layer electrode pattern 69, and FIG. 36C illustrates the lower-layer electrode pattern 68 and the upper-layer electrode pattern 69 in an overlapped state.

Since the pitch of the lower-layer electrode fingers is decreased as illustrated in FIG. 36C in the present embodiment the lower-layer electrode finger is definitely laterally exposed out of the outline of the upper-layer electrode finger. There is no area where the upper-layer electrode fingers are adjacent to each other with no lower-layer electrode finger interposed therebetween.

When the simulation test was performed on the fifth example, L1/S1 of the upper-layer electrode fingers was fixed to L1/S1=3/3 μm. On the other hand, L2/S2 of the lower-layer electrode fingers was set to be L2/S2=1.5/1.5 μm. In addition, another simulation test was performed with L2/S2 of the lower-layer electrode fingers changed to L2/S2=1.0/1.0 μm. In this way, the simulation tests were performed to examine the effect of the lower-layer electrode finger on the pixel capacitance and transmittance with the pitch of the lower-layer electrode fingers changed.

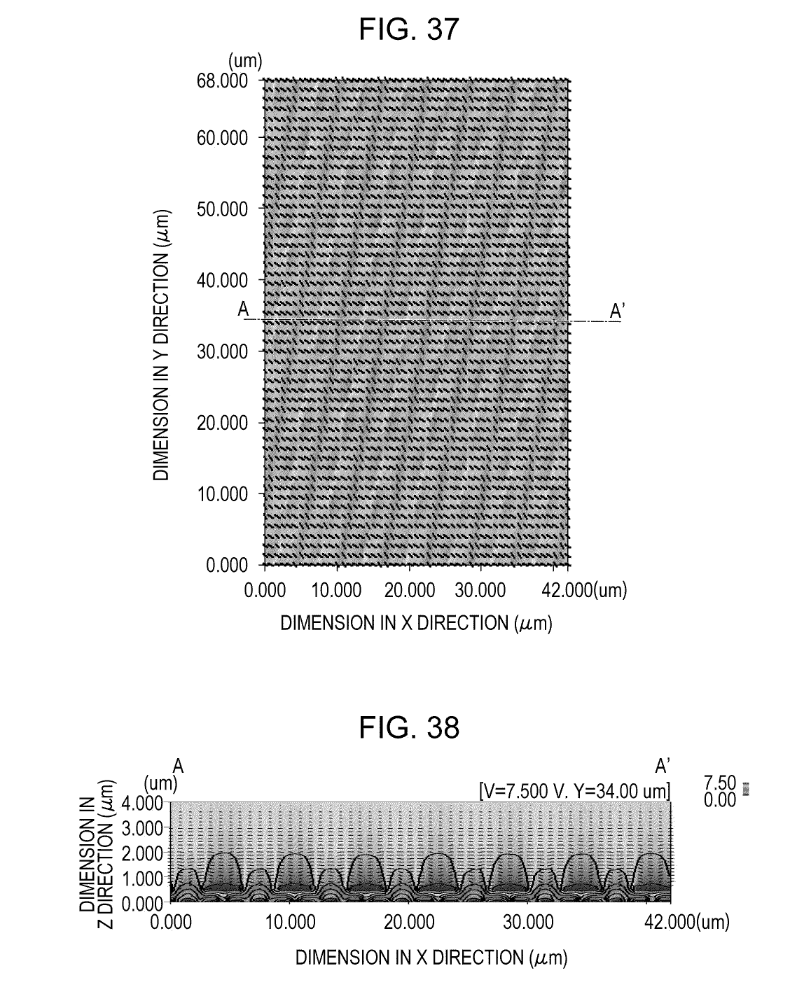

FIG. 37 illustrates a transmittance distribution within the patterns illustrated in FIG. 36A through FIG. 36C.

The transmittance is substantially uniform and generally good.

FIG. 38 is a sectional view of the liquid crystal layer at a location half way down the transmittance distribution chart of FIG. 37 from the top (the area along A-A′ line).

It was understood that the in-plane electric field was sufficiently generated and that the liquid crystal molecules were almost uniformly aligned.

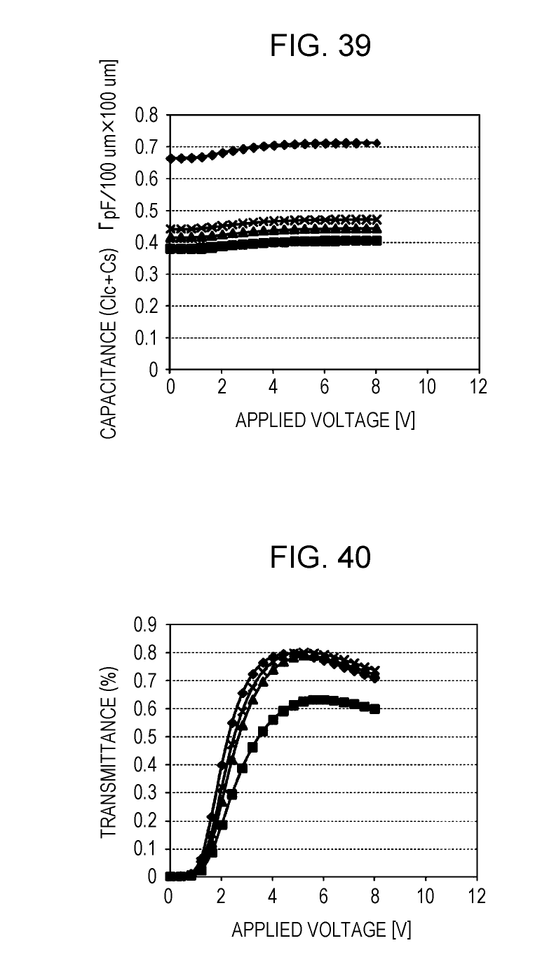

FIG. 39 is a plot of a relationship between an applied voltage and a pixel capacitance (Clc+Cs). The horizontal axis in FIG. 39 represents the applied voltage [V]. The vertical axis in FIG. 39 represents the pixel capacitance [pF/100 μm×100 μm]. FIG. 39 plots data obtained with L2/S2 of the lower-layer electrode fingers L2/S2=3/3 μm (data represented by solid squares in FIG. 39 corresponding to the first example with the pitch of the lower-layer electrode not reduced), L2/S2=1.5/1.5 μm (data represented by solid triangles in FIGS. 39), and L2/S2=1.0/1.0 μm (data represented by letters X in FIG. 39).

The calculation of the plot of FIG. 39 revealed that the ratio L2/S2=3/3 μm (first embodiment) reduced the pixel capacitance to 57% with respect to the known FFS type. In contrast, the reduction of the pitch of the lower-layer electrode fingers to L2/S2=1.5/1.5 μm reduced the pixel capacitance to 62% with respect to the known FFS type. The ratio of L2/S2=1.0/1.0 μm reduced the pixel capacitance to 66% with respect to the known FFS type.

Table 3 lists the calculation results of the pixel capacitance.

TABLE 3

| S2 | L2 | Pixel capacitance |
|---|---|---|
| (μm) | (μm) | (Clc + Cs) |
| 3.0 | 3.0 | −43% |
| 1.5 | 1.5 | −38% |
| 1.0 | 1.0 | −34% |

FIG. 40 is a plot of a relationship between an applied voltage and transmittance in the fifth example. The horizontal axis in FIG. 40 represents the applied voltage [V]. The vertical axis in FIG. 40 represents transmittance [%]. However, note that the transmittance here does not includes that of the polarizers, and is only the transmittance of the liquid crystal cell alone.

As illustrated in the plot of FIG. 40, the transmittance with L2/S2=3/3 μm (corresponding to the first example as represented by solid squares in FIG. 40) is substantially reduced with respect to the transmittance of the FFS type. In accordance with the fifth example, in contrast, with each of L2/S2=1.5/1.5 μm (as represented by solid triangles in FIGS. 40) and L2/S2=1.0/1.0 μm (as represented by letters X in FIG. 40), the transmittance increases from the transmittance with L2/S2=3/3 μm, and the transmittance at almost the same level as the transmittance in the FFS type results.

In order to ensure transmittance, the reduction of the electrode finger pitch is not effective on the upper-layer electrode fingers but effective on the lower-layer electrode only. The reason for this is described below.

A comparative example was presumed on the electrode design that the lower-layer electrode fingers with L2/S2=3/3 μm are obliquely arranged at 10 degrees while the upper-layer electrode fingers with L1/S1=1/1 μm are vertically extended. Simulation tests were performed on the comparative example.

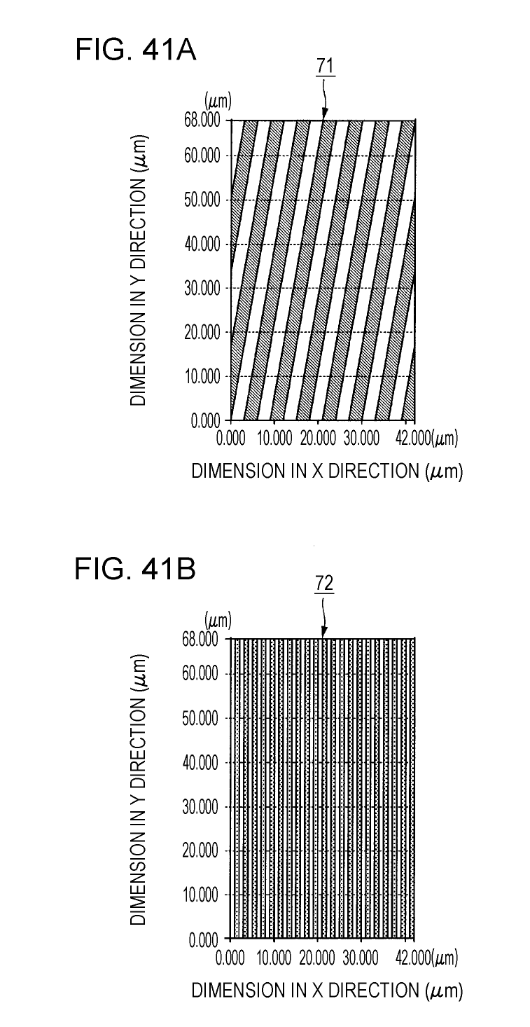

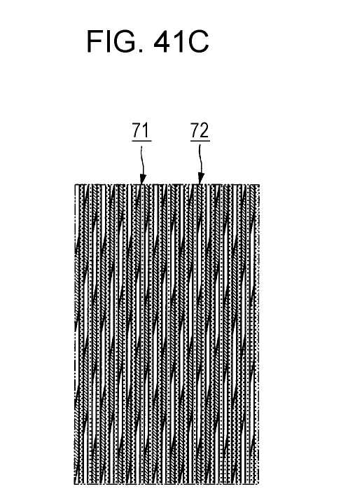

FIG. 41A illustrates a lower-layer electrode pattern 71 used in the simulation test of the comparative example. FIG. 41B illustrates an upper-layer electrode pattern 72. FIG. 41C illustrates the lower-layer electrode pattern 71 and the upper-layer electrode pattern 72 in an overlapped state.

As illustrated in FIG. 41C, it was understood that the use of a smaller pitch of the upper-layer electrode fingers in the comparative example permitted fine upper-layer electrode fingers to be arranged densely over the lower-layer electrode fingers, and that the exposed area of the lower-layer electrode fingers was reduced to an extremely small value.

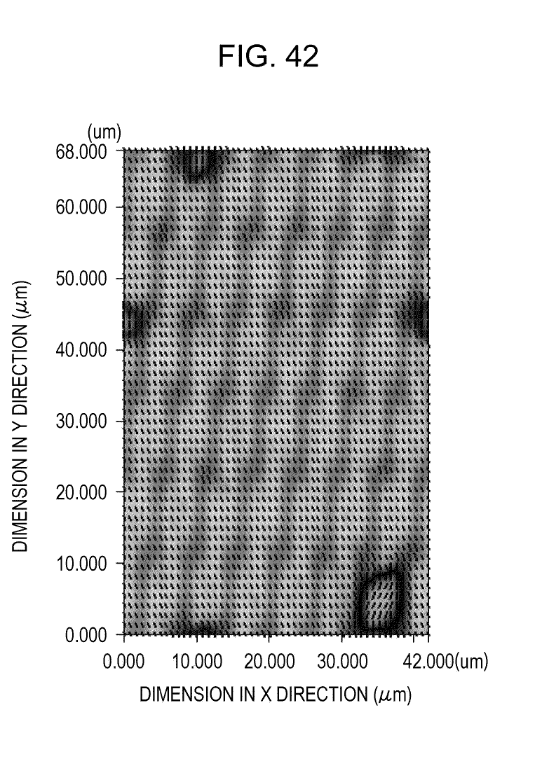

FIG. 42 illustrates a transmittance distribution within the patterns of FIG. 41A through FIG. 41C.

In an area where the lower-layer electrode finger is not exposed, the movement of the liquid crystal molecules is very small, and transmittance is decreased. As in the transmittance distribution chart of FIG. 42, many periodic black areas are observed.

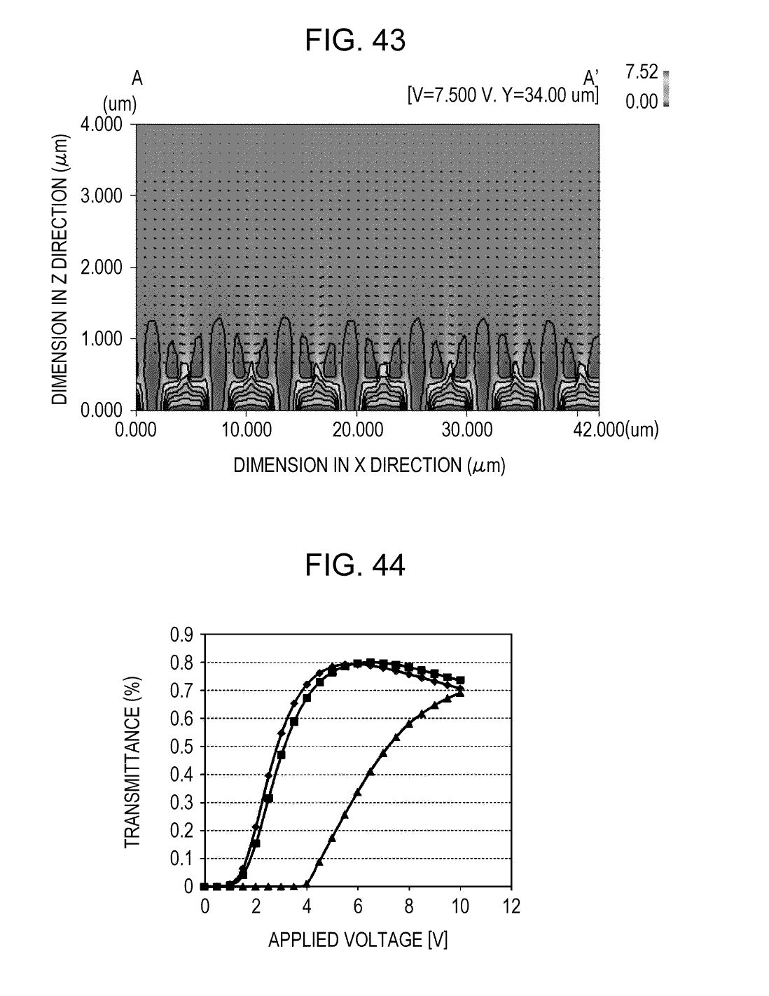

FIG. 43 is a sectional view of the area of the liquid crystal layer at half way down the transmittance distribution chart of FIG. 42 from the top (the area along line A-A′).

In the comparative example, the upper-layer electrode finger functions as a virtually overall shield, and the potential of the lower-layer electrode finger does not appear to the liquid crystal layer side. For this reason, the in-plane electric field is not sufficiently generated. As a result, it was understood that the liquid crystal molecules are not sufficiently aligned.

FIG. 44 is a plot of a relationship between an applied voltage and transmittance in the comparative example. The horizontal axis in FIG. 44 represents the applied voltage [V]. The vertical axis in FIG. 44 represents the transmittance [%]. However, note that the transmittance here does not includes that of the polarizers, and is only the transmittance of the liquid crystal cell alone. As illustrated in FIG. 44, the relationship between the applied voltage and the transmittance in the comparative example is represented by solid triangles. The relationship between the applied voltage and the transmittance in the fifth example is represented by solid squares. The relationship between the applied voltage and the transmittance in the known FFS type is represented by solid diamonds.

If the pitch of the lower-layer electrode fingers is decreased (in the fifth example), the transmittance at almost the same level as the transmittance in the known FFS is obtained as illustrated in FIG. 44. However, if the pitch of the upper-layer electrode fingers is decreased (in the comparative example), the transmittance becomes substantially smaller than the known FFS type or when a smaller pitch is used on the lower-layer electrode fingers. It is understood that a threshold voltage (a voltage raised by transmittance) increases because it is difficult for the in-plane electric field to impinge on the liquid crystal layer in the comparative example.

It is understood from the above results that, from the standpoint of ensuring the transmittance, the decreasing of the pitch of the upper-layer electrode fingers is not desirable, but the decreasing of the pitch of the lower-layer electrode fingers is desirable. On the other hand, from the standpoint of reducing the pixel capacitance, or from the standpoint of reducing the capacitance variation responsive to a misalignment between the electrodes, the pitch of the upper-layer electrode fingers may be decreased instead of decreasing the pitch of the lower-layer electrode fingers.

### Sixth Example

Next, the liquid crystal display device of the sixth embodiment illustrated in FIG. 17 is a sixth example.

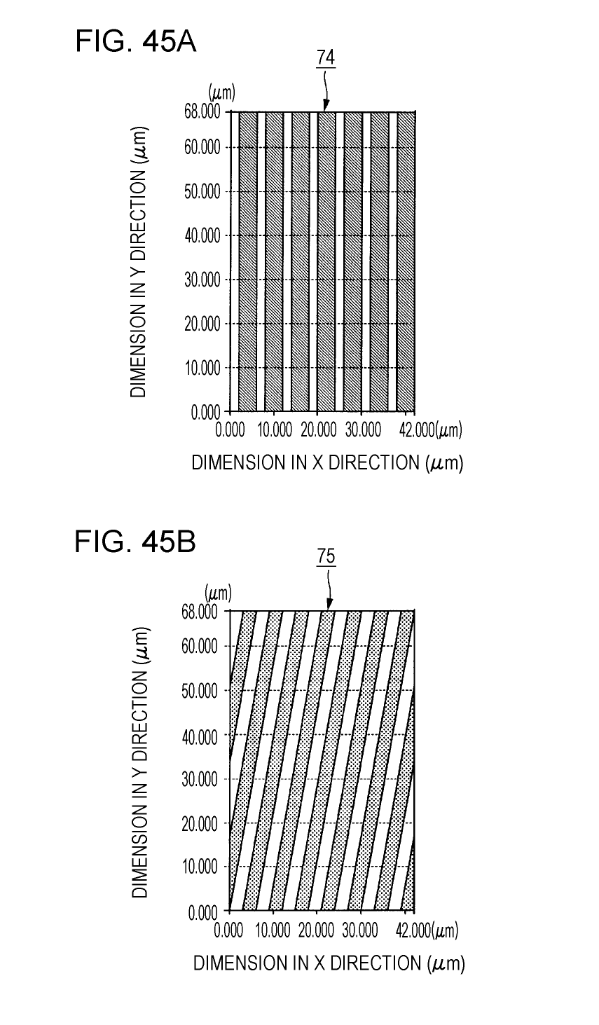

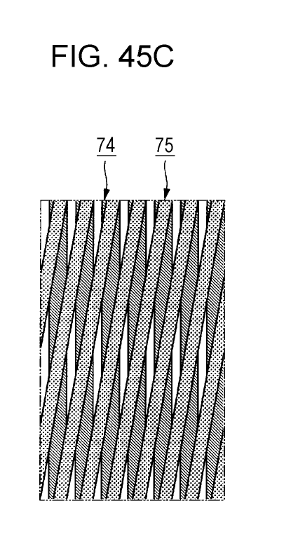

In the sixth example, FIG. 45A illustrates a lower-layer electrode pattern 74 used in the simulation test, FIG. 45B illustrates an upper-layer electrode pattern 75, and FIG. 45C illustrates the lower-layer electrode pattern 74 and the upper-layer electrode pattern 75 in an overlapped state.

As illustrated in FIG. 45C, the lower-layer electrode fingers are increased in line width without changing the pitch thereof, and the lower-layer electrode finger is definitely externally exposed out of the outline of the upper-layer electrode finger. There is no area where the upper-layer electrode fingers are adjacent with no lower-layer electrode fingers interposed therebetween.

When the simulation test was performed on the sixth example, L1/S1 of the upper-layer electrode fingers was fixed to L1/S1=3/3 μm as the above example. On the other hand, L2/S2 of the lower-layer electrode fingers was set to be L2/S2=4/2 μm.

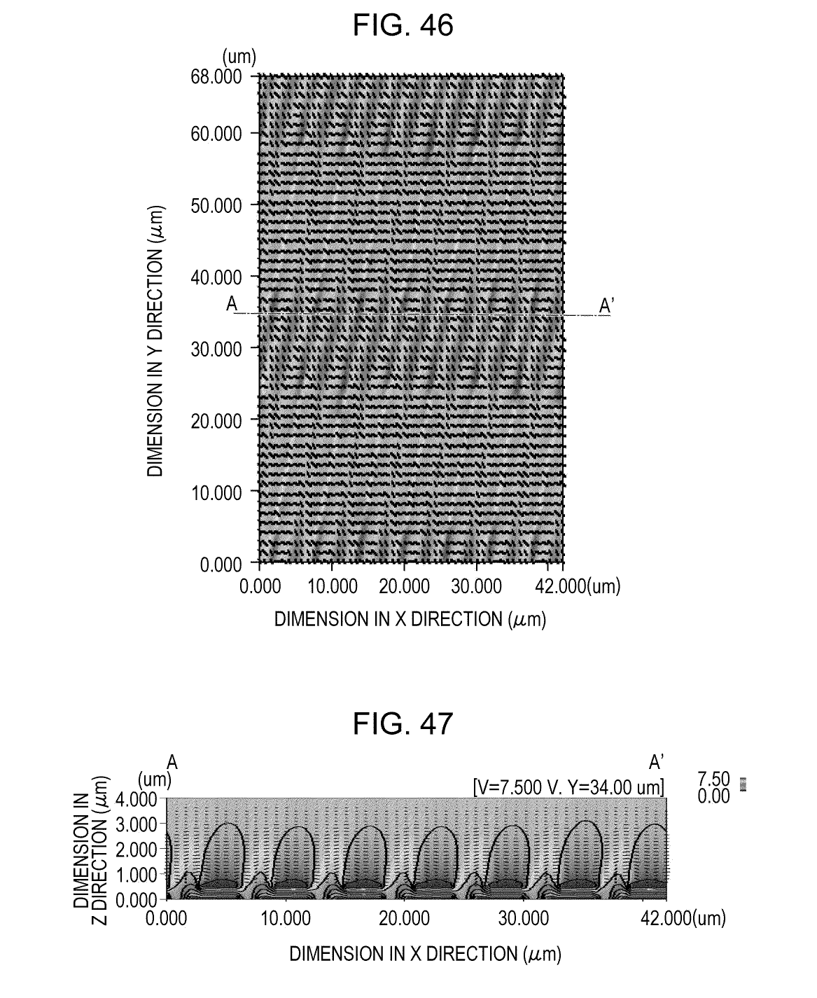

FIG. 46 illustrates a transmittance distribution within the patterns illustrated in FIG. 45A through FIG. 45C.

The transmittance is substantially uniform and generally good.

FIG. 47 is a sectional view of the liquid crystal layer at a location half way down the transmittance distribution chart of FIG. 46 from the top.

It was understood that the in-plane electric field was sufficiently generated and that the liquid crystal molecules were almost uniformly aligned.

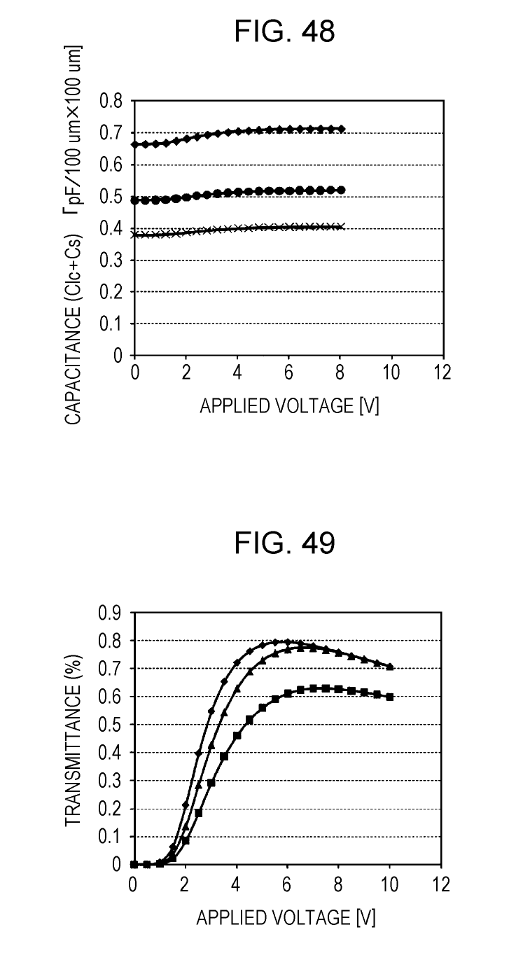

FIG. 48 is a plot of a relationship between an applied voltage and a pixel capacitance (Clc+Cs). The horizontal axis in FIG. 48 represents the applied voltage [V]. The vertical axis in FIG. 48 represents the pixel capacitance [pF/100 μm×100 μm].

In the sixth example (as represented by solid circles in FIG. 48) in the plot of FIG. 48, the increase of the line width L2 of the lower-layer electrode finger increased the area of the overlapping region of the lower-layer electrode fingers and the upper-layer electrode fingers in comparison with L2/S2=3/3 μm (corresponding to the first example as represented by letters X in FIG. 48). As a result, the pixel capacitance increases. The pixel capacitance is still sufficiently decreased in comparison with the known FFS type (represented by solid diamonds in FIG. 48).

FIG. 49 is a plot of a relationship between an applied voltage and transmittance in the sixth example. The horizontal axis in FIG. 49 represents the applied voltage [V]. The vertical axis in FIG. 49 represents the transmittance [%]. However, note that the transmittance here does not includes that of the polarizers, and is only the transmittance of the liquid crystal cell alone.

As represented by the plot of FIG. 49, the transmittance with L2/S2=3/3 μm (corresponding to the first example represented by solid squares in FIG. 49) is greatly decreased with respect to the transmittance in the known FFS type (represented by solid diamonds in FIG. 49). In contrast, in the sixth example (represented by solid triangles in FIG. 49), the improved alignment state of the liquid crystal layer results in an increase in the transmittance in comparison with the first example, and achieves the transmittance at almost the same level as the known FFS type.

### Seventh Example

Next, the liquid crystal display device of the seventh embodiment illustrated in FIG. 19 is a seventh example.

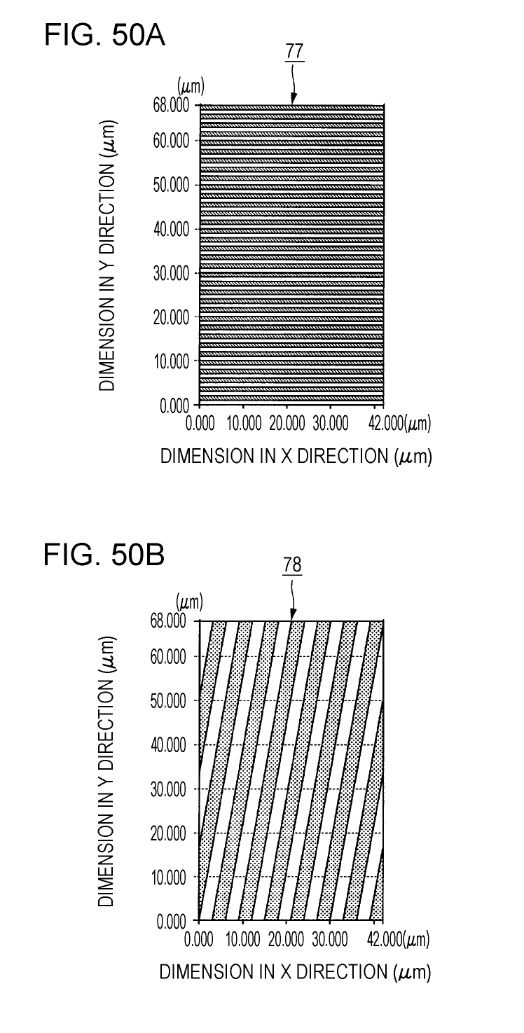

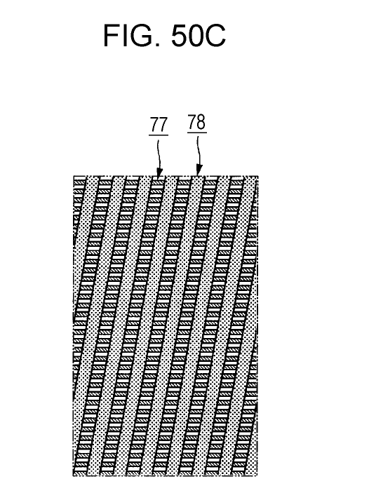

In the seventh example, FIG. 50A illustrates a lower-layer electrode pattern 77 used in the simulation test, FIG. 50B illustrates an upper-layer electrode pattern 78, and FIG. 50C illustrates the lower-layer electrode pattern 77 and the upper-layer electrode pattern 78 in an overlapped state.

As illustrated in FIG. 50C, the seventh example is different from the first through sixth example in the longitudinal direction of the lower-layer electrode fingers. However, the seventh example is identical to the fifth example in that a smaller pitch of the lower-layer electrode fingers is used, and the same operation and advantages as those of the fifth example are provided. More specifically, the use of the smaller pitch of the lower-layer electrode fingers causes the lower-layer electrode fingers to be definitely laterally exposed out of the outline of the upper-layer electrode fingers, and there is no area where the upper-layer electrode fingers are adjacent without no lower-layer electrode fingers interposed therebetween.

When the simulation test was performed on the seventh example, L1/S1 of the upper-layer electrode fingers was fixed to L1/S1=3/3 μm. On the other hand, L2/S2 of the lower-layer electrode fingers was set to be L2/S2=1.5/1.5 μm.

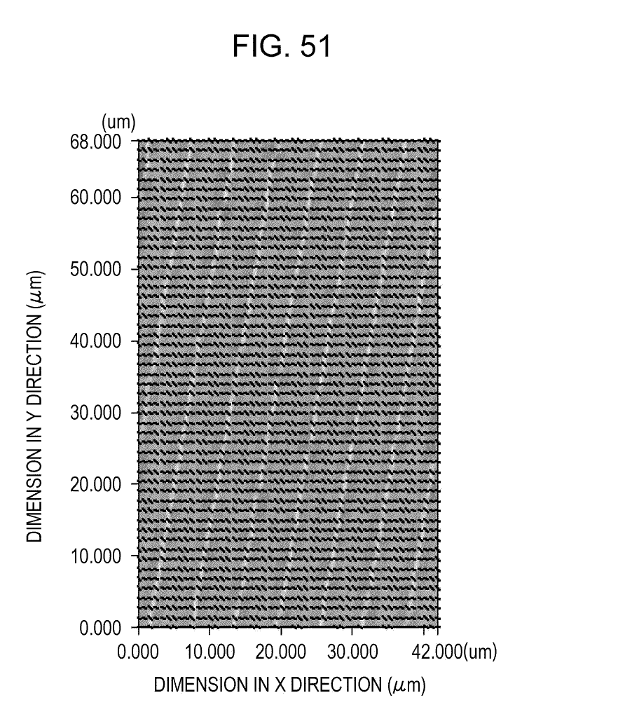

FIG. 51 illustrates a transmittance distribution within the patterns illustrated in FIG. 50A through FIG. 50C.

The transmittance is substantially uniform and generally good.

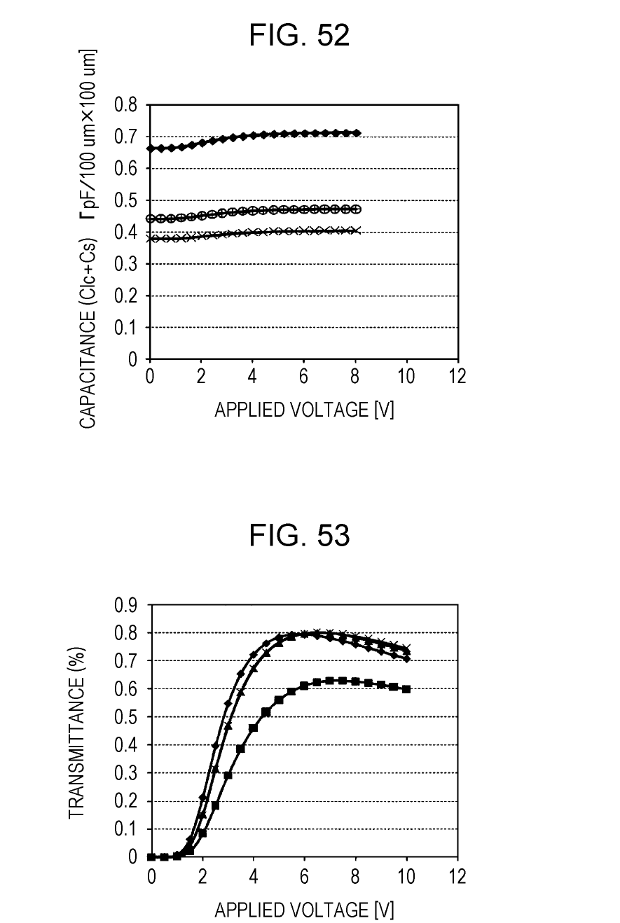

FIG. 52 is a plot of a relationship between an applied voltage and a pixel capacitance (Clc+Cs). The horizontal axis in FIG. 52 represents the applied voltage [V]. The vertical axis in FIG. 52 represents the pixel capacitance [pF/100 μm×100 μm]. In addition to data (represented by symbols 1 in FIG. 52) that indicates the relationship in the seventh example between the applied voltage and the pixel capacitance (Clc+Cs), FIG. 52 also illustrates data of the first example (represented by letters X with L2/S2=3/3 μm), data of the fifth example (represented by blank circles with L2/S2=1.5/1.5 μm with the longitudinal direction of the lower-layer electrode fingers aligned with the vertical direction), and data in the known FFS type (represented by solid diamonds).

As represented by the plot of FIG. 52, the pixel capacitance of the seventh example is increased and is slightly higher than the pixel capacitance of the first example. However, the pixel capacitance of the seventh example is at almost the same level as the pixel capacitance of the fifth example. It was thus understood that the lower-layer electrode fingers with only the direction thereof changed but with the dimensions thereof unchanged did not affect the pixel capacitance.

FIG. 53 is a plot of a relationship between an applied voltage and transmittance in the seventh example. The horizontal axis in FIG. 53 represents the applied voltage [V]. The vertical axis in FIG. 53 represents the transmittance [%]. However, note that the transmittance here does not includes that of the polarizers, and is only the transmittance of the liquid crystal cell alone. In addition to data (represented by letters X in FIG. 53) that indicates the relationship in the seventh example between the applied voltage and the transmittance, FIG. 53 also illustrates data of the first example (represented by solid squares with L2/S2=3/3 μm), data of the fifth example (represented by solid triangles with L2/S2=1.5/1.5 μm with the longitudinal direction of the lower-layer electrode fingers aligned with the vertical direction), and data in the known FFS type (represented by solid diamonds).

As represented by the plot of FIG. 53, the transmittance with L2/S2=3/3 μm (the first example) is greatly reduced with respect to the transmittance of the known FFS type. In contrast, the seventh example achieves a transmittance at almost the same level as that of the FFS type. There is practically no difference in transmittance between the seventh example and the fifth example. It was thus understood that the lower-layer electrode fingers with only the direction thereof changed but with the dimensions thereof unchanged did not affect the transmittance.

### [Configuration Example of Liquid Crystal Display Device]

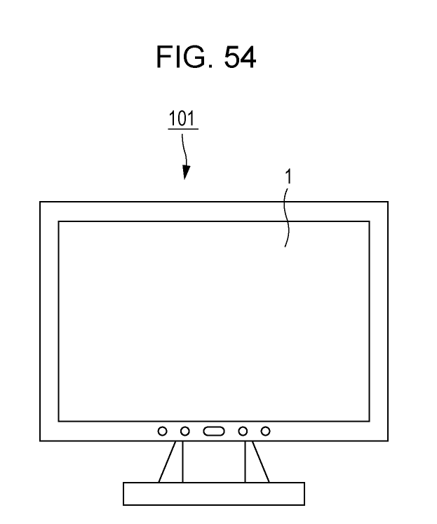

A configuration example of the liquid crystal display device is described with reference to FIG. 54.

FIG. 54 is a plan view diagrammatically illustrating a liquid crystal television as the configuration example of the liquid crystal display device.

The liquid crystal television 101 as the configuration example includes the liquid crystal display device 1 of each of the first through seventh embodiments as a display screen. A liquid crystal panel is arranged on a viewer's side (reader's side of FIG. 54), and a backlight (surface light source) is arranged on the side opposite the viewer's side (back side of FIG. 21).

The liquid crystal television 101 with the liquid crystal display device 1 of each of the embodiments becomes a liquid crystal television that can display a high-quality image.

Also, the liquid crystal display device of the embodiments finds mobile applications, such a portable electronic device. In such a case, a mobile device with low power consumption may result.

The technical scope of the mode of the present invention is not limited to the embodiments and examples described above. The present invention may be changed in a variety of fashions without departing from the scope of the mode of the present invention.

For example, the lower-layer electrodes and the upper-layer electrodes intersect at an angle of 10 degrees or 80 degrees in the embodiments. The lower-layer electrodes may intersect the upper-layer electrodes at any other angle as long as the lower-layer electrodes and the upper-layer electrodes are neither in parallel to or nor in perpendicular to. In such a case, the same advantages as those of the embodiments are provided.

The point of the mode of the present invention is to design each electrode from the start with the intention that the lower-layer electrodes are to intersect the upper-layer electrodes. The liquid crystal display device in the mode of the present invention is different from a liquid crystal display device in which the lower-layer electrodes happen to intersect the upper-layer electrodes as a result of a misalignment in a rotation direction in a substrate plane in a manufacturing process. Therefore, in a desirable design as illustrated in FIG. 2, portions other than the electrode fingers, such as the connection portions, are arranged in parallel with the lower-layer electrodes and the upper-layer electrodes, and only the electrode fingers intersect.

In the simulation tests on the examples, a silicon nitride film as an inorganic material film having a dielectric constant of ∈=6 is presumed as the insulating film interposed between the lower-layer electrode and the upper-layer electrode. Alternatively, another inorganic material film such as of photosensitive acrylic resin (for example, trade name: PC403 having a dielectric constant ∈=3.7, manufactured by JSR Corporation) may be used. The use of the insulating film having such a smaller dielectric constant as this permits the load capacitance to be further reduced.

Other factors, including shapes, dimensions, film thickness, layout, and materials of each elements of the liquid crystal display device, used in the embodiments and examples, are not limited to those described in the embodiments and example, and may be modified as appropriate.

### INDUSTRIAL APPLICABILITY

The mode of the present invention finds applications in liquid crystal display devices.

### REFERENCE SIGNS LIST

1 . . . liquid crystal display device, 6 . . . TFT array substrate, 7 . . . counter substrate, 8 . . . liquid crystal layer, 20 . . . upper-layer electrode, 22, 35, 39, 42, 46, 49, and 52 . . . lower-layer electrodes, 23, 36, 40, 43, 47, 50, and 53 . . . lower-layer electrode fingers, 25 . . . upper-layer electrode finger, 28 . . . intersection region, 37 and 41 . . . expanded portions, 44 . . . aperture

1-8. (canceled)

9. A liquid crystal display device comprising:
a pair of substrates disposed to be opposed to each other,
a liquid crystal layer sandwiched between the pair of substrates,
a lower-layer electrode disposed between one of the substrates and the liquid crystal layer,
an insulating film that covers the lower-layer electrode, and
an upper-layer electrode disposed on the insulating film,
wherein the lower-layer electrode includes a plurality of lower-layer electrode fingers spaced a predetermined interval apart from each other,
wherein the upper-layer electrode includes a plurality of upper-layer electrode fingers spaced a predetermined interval apart,
wherein the plurality of lower-layer electrode fingers intersects the plurality of upper-layer electrode fingers at a predetermined angle greater than 0 degrees and smaller than 90 degrees if viewed from a direction normal to the one of the substrates, wherein the one of the substrates comprises a plurality of pixel regions disposed in a matrix,
wherein the plurality of lower-layer electrode fingers extends in parallel with a layout direction of the plurality of pixel regions, and the plurality of upper-layer electrode fingers extends at a slant angle with respect to the layout direction of the plurality of pixels, and
wherein an expression L1+S1>L2+S2 or expression L1+S1=L2+S2 holds where L1 represents a line width of each of the upper-layer electrode fingers, S1 represents a line spacing between adjacent upper-layer electrode fingers, L2 represents a line width of each of the lower-layer electrode fingers, and S2 represents a line spacing between adjacent lower-layer electrode fingers.

10. The liquid crystal display device according to claim 9, wherein a line width of a first region of each of the lower-layer electrode fingers in at least one close area to an intersection region of each of the lower-layer electrode fingers and each of the upper-layer electrode fingers is larger than a line width of a second region that is adjacent to the first region and other than the at least one close area.

11. The liquid crystal display device according to claim 10, wherein an outline of a portion of the first region of each of the lower-layer electrode fingers adjacent to the second region makes an angle greater than 0 degrees and smaller than 90 degrees with respect to a longitudinal direction of the lower-layer electrode fingers.

12. The liquid crystal display device according to claim 4, wherein the outline of the portion of the first region of each of the lower-layer electrode fingers adjacent to the second region is generally parallel with an outline of each of the upper-layer electrode fingers.

13. The liquid crystal display device according to claim 9, wherein each of the lower-layer electrode fingers has a cutout in at least one of the intersection regions of the lower-layer electrode fingers and the upper-layer electrode fingers.

14. The liquid crystal display device according to claim 9, wherein the expression L1+S1=L2+S2 and an expression L1<L2 hold.

15. The liquid crystal display device according to claim 9, wherein an expression L1<L2 holds.

16. A liquid crystal display device comprising:
a pair of substrates disposed to be opposed to each other,
a liquid crystal layer sandwiched between the pair of substrates,
a lower-layer electrode disposed between one of the substrates and the liquid crystal layer,
an insulating film that covers the lower-layer electrode, and
an upper-layer electrode disposed on the insulating film,
wherein the lower-layer electrode includes a plurality of lower-layer electrode fingers spaced a predetermined interval apart from each other,
wherein the upper-layer electrode includes a plurality of upper-layer electrode fingers spaced a predetermined interval apart,
wherein the plurality of lower-layer electrode fingers intersects the plurality of upper-layer electrode fingers at a predetermined angle greater than 0 degrees and smaller than 90 degrees if viewed from a direction normal to the one of the substrates,
wherein the plurality of lower-layer electrode fingers extends in parallel with a layout direction of the plurality of pixel regions, and the plurality of upper-layer electrode fingers extends at a slant angle with respect to the layout direction of the plurality of pixels, and
wherein a line width of a first region of each of the lower-layer electrode fingers in at least one close area to an intersection region of each of the lower-layer electrode fingers and each of the upper-layer electrode fingers is larger than a line width of a second region that is adjacent to the first region and other than the at least one close area.

17. The liquid crystal display device according to claim 16, wherein an outline of a portion of the first region of each of the lower-layer electrode fingers adjacent to the second region makes an angle greater than 0 degrees and smaller than 90 degrees with respect to a longitudinal direction of the lower-layer electrode fingers.

18. The liquid crystal display device according to claim 17, wherein the outline of the portion of the first region of each of the lower-layer electrode fingers adjacent to the second region is generally parallel with an outline of each of the upper-layer electrode fingers.

19. The liquid crystal display device according to claim 16, wherein each of the lower-layer electrode fingers has a cutout in at least one of the intersection regions of the lower-layer electrode fingers and the upper-layer electrode fingers.

20. The liquid crystal display device according to claim 16, wherein an expression L1+S1>L2+S2 holds where L1 represents a line width of each of the upper-layer electrode fingers, S1 represents a line spacing between adjacent upper-layer electrode fingers, L2 represents a line width of each of the lower-layer electrode fingers, and S2 represents a line spacing between adjacent lower-layer electrode fingers.

21. The liquid crystal display device according to claim 16, wherein expressions L1+S1=L2+S2 and L1<L2 hold where L1 represents a line width of each of the upper-layer electrode fingers, S1 represents a line spacing between adjacent upper-layer electrode fingers, L2 represents a line width of each of the lower-layer electrode fingers, and S2 represents a line spacing between adjacent lower-layer electrode fingers.
